(19) United States
(12) Patent Application Publication
(10) Pub. No.: US 2025/0291407 A1
(43) Pub. Date: Sep. 18, 2025

(54) Budgets Enforcement for Computing Devices and Computing Infrastructure

(71) Applicant: Oracle International Corporation, Redwood Shores, CA (US)

(72) Inventors: Zachary Hawk Berkshire, Lexington, KY (US); Christopher Caldwell, Midway, KY (US); Jonathan Luke Herman, Seattle, WA (US); Nathaniel Alexander Jones, Lexington, KY (US); Sumeet Kochar, Cary, NC (US); Jeffrey Francis Phillips, Lexington, KY (US); Joshua Potter, Rogersville, TN (US); Justin D. Proffitt, La Grange, KY (US); Erik Paul Reiter, Amelia, OH (US); Yuxin Zhong, Kenmore, WA (US)

(73) Assignee: Oracle International Corporation, Redwood Shores, CA (US)

(21) Appl. No.: 19/072,438

(22) Filed: Mar. 6, 2025

Related U.S. Application Data
(60) Provisional application No. 63/565,749, filed on Mar. 15, 2024.
(60) Provisional application No. 63/565,755, filed on Mar. 15, 2024.
(60) Provisional application No. 63/565,761, filed on Mar. 15, 2024.

(51) Int. Cl. G06F 1/3296

(52) U.S. Cl. CPC G06F 1/3296

(57) ABSTRACT

Techniques are disclosed for enforcing budgeting for a network of devices using a hierarchy of controllers. A controller in the hierarchy monitors the utilization of a resource by a device in the network, and the controller may compare an amount of that resource being drawn by the device to an allocation of that resource defined in a restriction applicable to the device. If the device exceeds the defined allocation of the resource, the controller determines enforcement thresholds for descendant devices in the network that are distributed portions of the device's defined allocation of that resource. The controller determines enforcement thresholds for the descendant devices based on the respective states of the descendant devices. For instance, the controller may determine the enforcement thresholds based on the relative importance of workloads assigned to the descendant devices, the health of descendant devices, the occupancy of the descendant devices, and/or other criteria.

### INCORPORATION BY REFERENCE; DISCLAIMER

Each of the following applications are hereby incorporated by reference: Application No. 63/565,749, filed on Mar. 15, 2024; Application No. 63/565,755 filed on Mar. 15, 2024; Application No. 63/565,761 filed on Mar. 15, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to generating budgets for devices. In particular, the present disclosure relates to generating budgets for devices that perform and/or facilitate computing operations.

### BACKGROUND

The term “data center” refers to a facility that includes one or more computing devices that are dedicated to processing, storing, and/or delivering data. A data center may be a stationary data center (e.g., a dedicated facility or a dedicated room of a facility) or a mobile data center (e.g., a containerized data center). A data center may be an enterprise data center, a colocation data center, a cloud data center, an edge data center, a hyperscale data center, a micro data center, a telecom data center, and/or another variety of data center. A data center may be a submerged data center, such as an underground data center or an underwater data center. A data center may include a variety of hardware devices, software devices, and/or devices that include both hardware and software. General examples of devices that may be included in a data center include compute devices, virtual devices, power infrastructure devices, network infrastructure devices, atmospheric regulation devices, security devices, monitoring and management devices, and other devices that support the operation of a data center. A data center may utilize a variety of resources, such as energy resources (e.g., electricity, coolant, fuel, etc.), compute resources (e.g., processing resources, memory resources, network resources, etc.), capital resources (e.g., cash spent on electricity, coolant, fuel, etc.), administrative resources (carbon credits, emission allowances, renewable energy credits, etc.), and/or other types of resources.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a machine learning engine in accordance with one or more embodiments;

FIG. 7 illustrates an example set of operations that may be performed by a machine learning engine in accordance with one or more embodiments;

FIG. 8 illustrates an example resource management system in accordance with one or more embodiments;

FIG. 9 illustrates an example set of operations for enforcing a budget in accordance with one or more embodiments;

FIG. 10 illustrates an example set of operations for assigning a workload in accordance with one or more embodiments; and

FIG. 11 illustrates an example architecture for practicing techniques described herein in accordance with an example embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. CLOUD COMPUTING TECHNOLOGY
3. COMPUTER SYSTEM
4. MACHINE LEARNING ARCHITECTURE
5. RESOURCE MANAGEMENT SYSTEM
6. BUDGET ENFORCEMENT
7. WORKLAD PLACEMENT
8. EXAMPLE EMBODIMENT
9. MISCELLANEOUS; EXTENSIONS

### 1. General Overview

One or more embodiments enforce a budget assigned to a device through a controller of the device that determines, in real time and based on current information, enforcement thresholds for child devices of the device that are designed to bring the device into compliance with the budget. The controller of the device determines if imposing enforcement thresholds on the child device is appropriate by monitoring the device's utilization of resources (e.g., electricity, network bandwidth, coolant, computer resources, etc.) that are allocated by the budget. For example, a budget assigned to a rack of hosts may limit the resources that can be utilized by the rack of hosts, and a controller of the rack of hosts monitors the resources that are utilized by the rack of hosts to determine if imposing enforcement thresholds on child devices of the rack of hosts is appropriate. As used herein, the term “child device” refers to a device that (a) is distributed resources from another device and/or (b) is a subcomponent of the other device. For example, a host is a child device of a rack of hosts that includes the host because (a) the rack of hosts may include a rack power distribution unit that distributes electricity to the host and/or (b) the host is a subcomponent of the rack of hosts. Conversely, a device is referred to as a “parent device” if that device (a) distributes resources to another device and/or (b) includes the other device as a subcomponent. For example, a rack of hosts is a parent device to a host included in the rack of hosts. As used herein, the term “enforcement threshold” refers to a restriction that is used to implement budgeting or respond to an emergency condition. For example, a controller of a rack of hosts may enforce a budget that is assigned to the rack of hosts by imposing enforcement thresholds on the hosts that are included in the rack of hosts. A controller of a device may determine enforcement thresholds for child devices of the device that are tailored to current statuses of the child devices. In determining enforcement thresholds for child devices of a device, a controller of the device may restrict some child devices instead of, prior to, and/or to a greater degree than other child devices depending on the current statuses of the respective child devices. Example inputs that may be a basis for determining enforcement threshold for child devices include the relative importance of workloads that are assigned to the child devices, occupancy of the child devices, the health of the child devices, and other information pertaining to the statuses of the child devices.

One or more embodiments enforce budgeting for a network of devices through a hierarchy of controllers that determine, in real time and based on current information, enforcement thresholds for descendant devices in the network of devices. As used herein, the term “descendant device” refers to a device that is directly or indirectly distributed resources through another device, and the term “ancestor device” refers to a device that directly or indirectly distributes resources to another device. A child device is an example of a descendant device, and a parent device is an example of an ancestor device. As an example, assume that a network of devices is a hierarchical electricity distribution network. In this example, an uninterruptible power sources is situated at the top of the network of devices, and the uninterruptible power source distributes electricity to power distribution units that are child devices of the uninterruptible power sources. The power distribution units of this example distribute electricity to busways that are child devices of the power distribution units, and the busways, in turn, distribute electricity to racks of hosts that are child devices of the busways. Finally, rack power distribution units of the racks of hosts distribute electricity to hosts that are child devices of the racks of hosts. In this example, a controller of any given device in the network of devices enforces a budget assigned to the given device and/or an enforcement threshold imposed on the given device by imposing enforcement thresholds on descendant devices of the given device. For instance, in this example, a controller of the uninterruptible power source implements a budget assigned to the uninterruptible power source by determining enforcement thresholds for the power distribution units, a controller of a power distribution unit implements a budget assigned to the power distribution unit and/or an enforcement threshold imposed on the power distribution unit by determining enforcement thresholds for the busways that draw power from the power distribution unit, a controller of a busway implements a budget assigned to the busway and/or an enforcement threshold imposed on the busway by determining enforcement thresholds for the racks of hosts that draw power from the busway, and a controller of a rack of hosts implements a budget assigned to the rack of hosts and/or an enforcement threshold imposed on the rack of hosts by determining enforcement thresholds for hosts that are included in the rack of hosts. In this example, an enforcement threshold imposed on a host may be enforced by a baseboard management controller of the host, by a compute control plane that manages user instances assigned to the host, by a user instance controller operating at a hypervisor level of the host, by an enforcement agent executing on a computing system of an owner of a user instance assigned to the host, and/or by other enforcement mechanisms.

One or more embodiments selectively assign a workload to a compute device based on static and/or dynamic characteristics of the workload, the compute device, other devices in a network of devices that includes the compute device, and/or other devices excluded from the network of devices that support the operation of the compute device. As used herein, a “compute device” refers to a device that provides computer resources (e.g., processing resources, memory resources, network resources, etc.) for computing activities (e.g., computing activities of data center users). A host (e.g., CPU servers, GPU chassis, etc.) is one example of a compute device. In an example, hosts are at the bottom of the network of devices, and the system selectively places user instances on the hosts based on static and/or dynamic characteristics of the user instances, hosts, ancestor devices of the hosts (e.g., racks of hosts, busways, etc.), devices that are outside the network of devices but nonetheless support the operation of the network of devices (e.g., atmospheric regulation devices, network infrastructure devices, etc.), and/or other information. As used herein, the term “user instance” refers to an execution environment configured to perform computing tasks of a user. Example user instances include containers, virtual machines, bare metal instances, dedicated hosts, and others.

One or more embodiments, predict the impact of assigning a workload to a compute device and determine if the workload should be assigned to the compute device based on the predicted impact. The system may evaluate the predicted impact of assigning the workload to the compute device with respect to restrictions that are associated with the compute device. If the system predicts that assigning a workload to a compute device does not pose a significant risk of exceeding a restriction that is associated with the compute device, the system may assign the workload to that compute device. A restriction associated with a compute device may be a restriction that is specifically applicable to that device. For example, the system may predict if placing a user instance on a host is likely to exceed a budget assigned to the host, an enforcement threshold imposed on the host, a hardware and/or software limitation of the host, and/or other restrictions that are specific to the host. Additionally, or alternatively, a restriction associated with a compute device may be a restriction that is not specific to the compute device. For example, the system may predict if placing a user instance on a host is likely to exceed a budget assigning to an ancestor device of the host, an enforcement threshold imposed on an ancestor device of the host, a hardware and/or software limitation of an ancestor device of the host, a hardware and/or software limitation of another device that supports the operation of the host (e.g., an atmospheric regulation device, a network infrastructure device, etc.), and/or other restrictions that are not specific to the host. The system may predict the impact of assigning the workload to the compute device by applying a trained machine learning model to characteristics of the workload, characteristics of a user associated with the workload, characteristics of the compute device, characteristics of ancestor devices of the compute device, characteristics of other devices that support the operation of the compute device, and/or other information.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

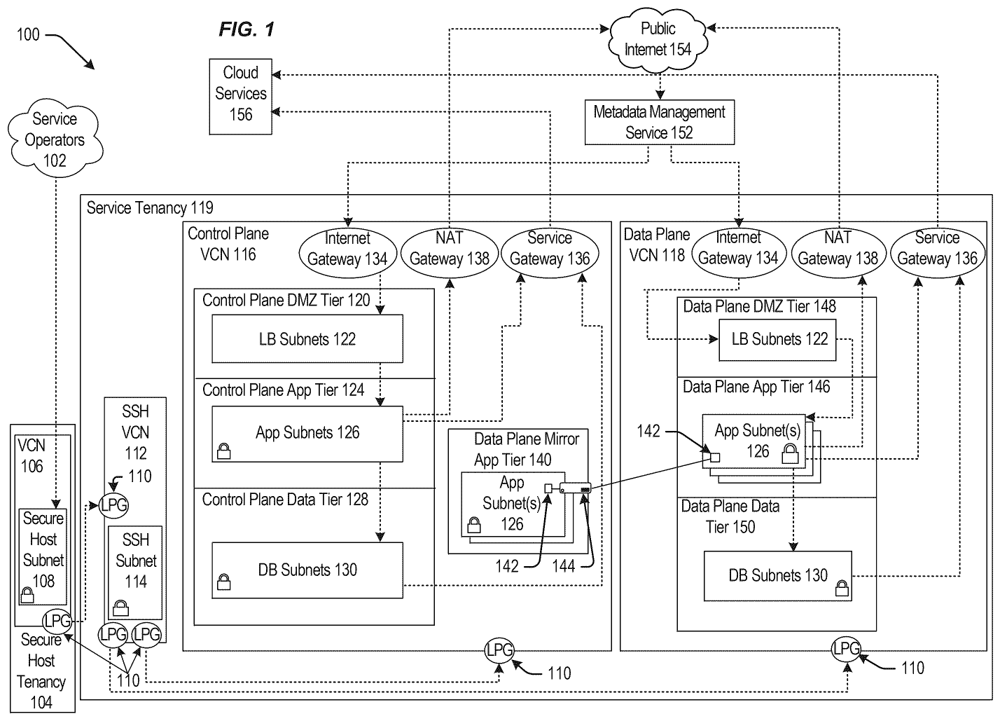

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively coupled to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

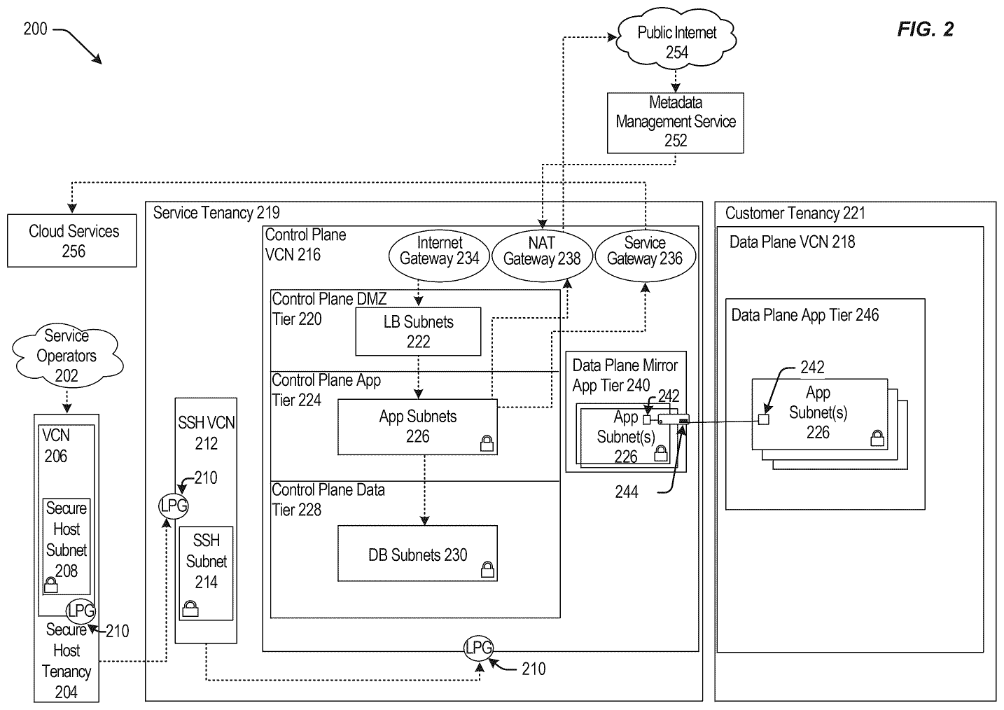

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively coupled to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

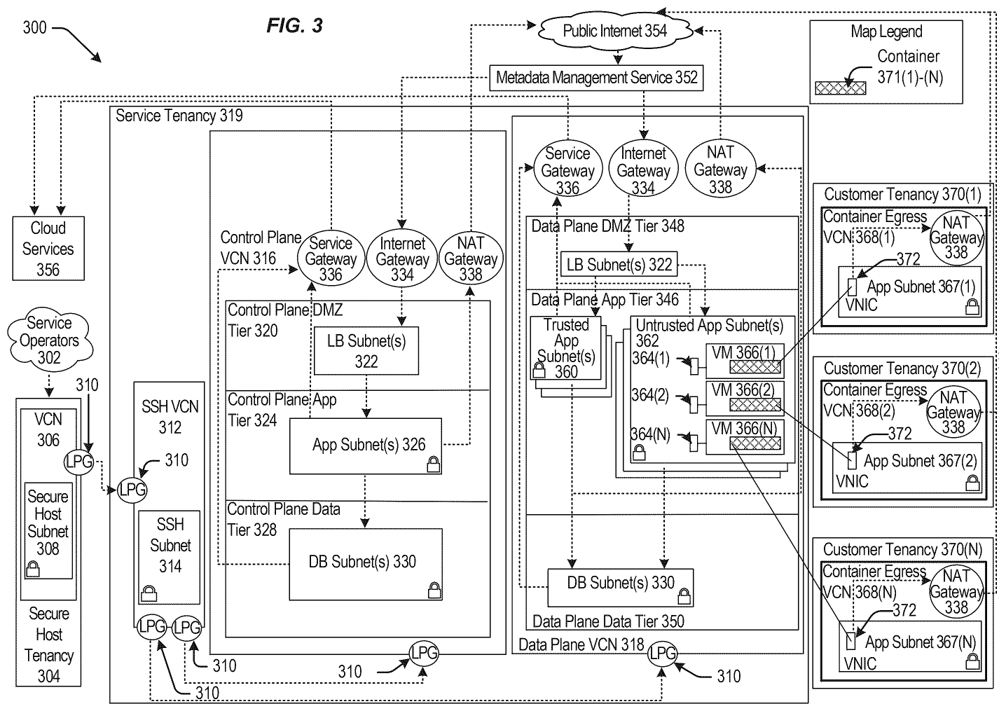

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively coupled to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

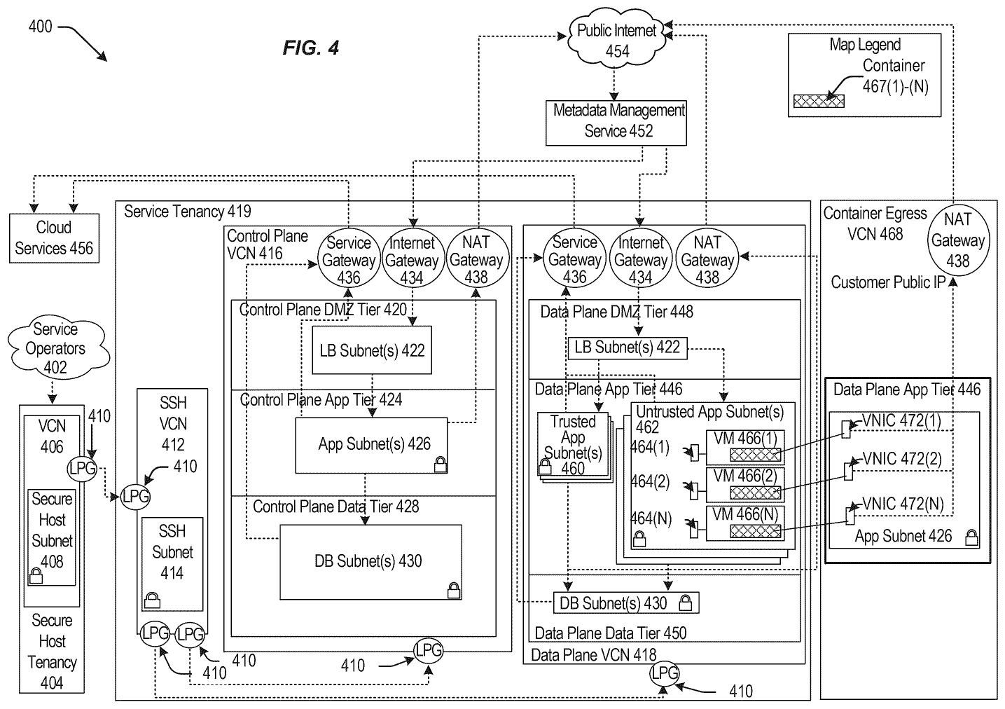

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively coupled to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant identifier (ID). Each network resource of the multi-tenant computer network is tagged with a tenant ID. A tenant is permitted access to a particular network resource when the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for each tenant, a set of applications that the tenant is authorized to access. For each application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

This application may include references to certain trademarks. Although the use of trademarks is permissible in patent applications, the proprietary nature of the marks should be respected and every effort made to prevent their use in any manner that might adversely affect their validity as trademarks.

### 3. Computer System

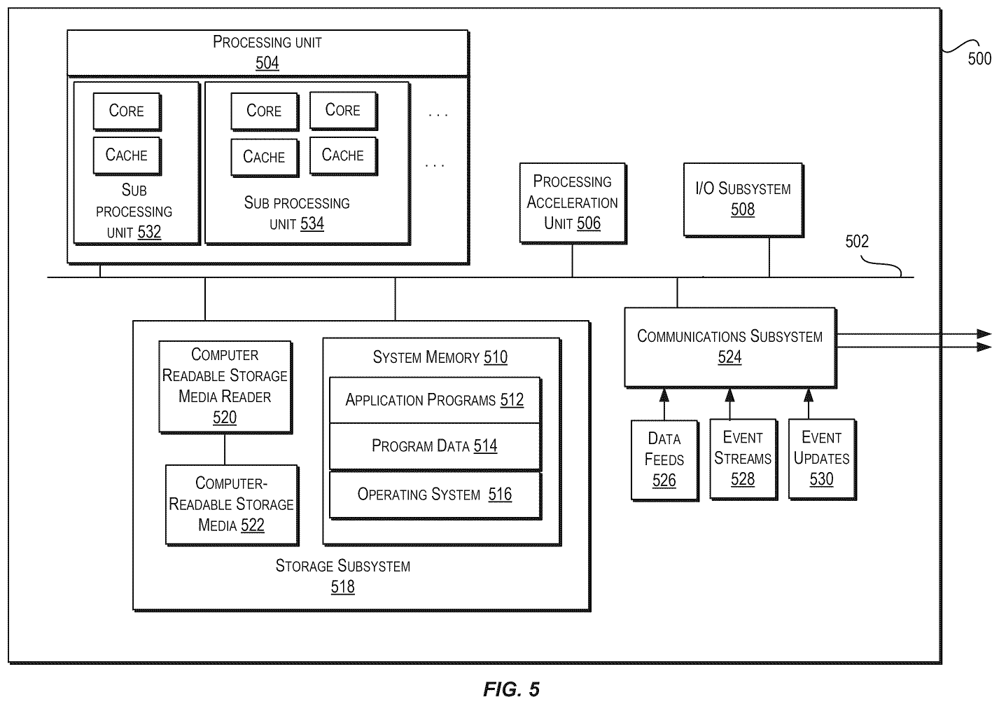

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with each other as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Machine Learning Architecture

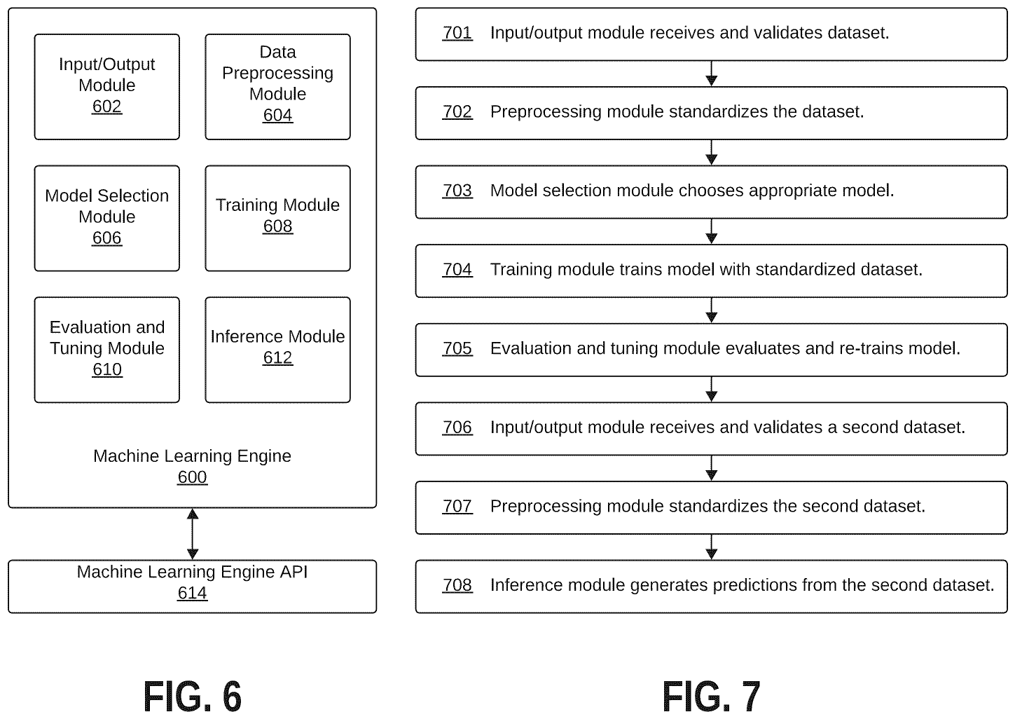

FIG. 6 illustrates a machine learning engine 600 in accordance with one or more embodiments. As illustrated in FIG. 6, machine learning engine 600 includes input/output module 602, data preprocessing module 604, model selection module 606, training module 608, evaluation and tuning module 610, and inference module 612.

In accordance with an embodiment, input/output module 602 serves as the primary interface for data entering and exiting the system, managing the flow and integrity of data. This module may accommodate a wide range of data sources and formats to facilitate integration and communication within the machine learning architecture.

In an embodiment, an input handler within input/output module 602 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 602 to be versatile in different operational contexts, whether processing historical datasets or streaming data.

In accordance with an embodiment, input/output module 602 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 602 includes an output framework designed to handle the distribution and exportation of outputs, predictions, or insights. Using the output framework, input/output module 602 formats these outputs into user-friendly and accessible formats, such as reports, visualizations, or data files compatible with other systems. Input/output module 602 also ensures secure and efficient transmission of these outputs to end-users or other systems in an embodiment and may employ encryption and secure data transfer protocols to maintain data confidentiality.

In accordance with an embodiment, data preprocessing module 604 transforms data into a format suitable for use by other modules in machine learning engine 600. For example, data preprocessing module 604 may transform raw data into a normalized or standardized format suitable for training ML models and for processing new data inputs for inference. In an embodiment, data preprocessing module 604 acts as a bridge between the raw data sources and the analytical capabilities of machine learning engine 600.

In an embodiment, data preprocessing module 604 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 604 may be configured to handle anomalies in different ways depending on context. Data preprocessing module 604 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 604 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 604 processes new data for inference, data preprocessing module 604 replicates the same preprocessing steps to ensure consistency with the training data format. This helps to avoid discrepancies between the training data format and the inference data format, thereby reducing the likelihood of inaccurate or invalid model predictions.

In an embodiment, model selection module 606 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 606 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 606 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 606 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 606 also considers computational efficiency and resource constraints. This is meant to help ensure the selected model is both accurate and practical in terms of computational and time requirements. In an embodiment, certain features of model selection module 606 are configurable such as a configured bias toward (or against) computational efficiency.

In accordance with an embodiment, training module 608 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 608 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 608 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 608 includes logic to handle different types of data and learning tasks. For instance, it includes different training routines for supervised learning (where the training data comes with labels) and unsupervised learning (without labeled data). In the case of deep learning models, training module 608 also manages the complexities of training neural networks that include initializing network weights, choosing activation functions, and setting up neural network layers.

In an embodiment, evaluation and tuning module 610 incorporates dynamic feedback mechanisms and facilitates continuous model evolution to help ensure the system's relevance and accuracy as the data landscape changes. Evaluation and tuning module 610 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 610 performs continuous model tuning by using hyperparameter optimization. Evaluation and tuning module 610 performs an exploration of the hyperparameter space using algorithms, such as grid search, random search, or more sophisticated methods like Bayesian optimization. Evaluation and tuning module 610 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 610 integrates data feedback and updates the model. Evaluation and tuning module 610 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 610 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 610 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 612 transforms data raw data into actionable, precise, and contextually relevant predictions. In addition to processing and applying a trained model to new data, inference module 612 may also include post-processing logic that refines the raw outputs of the model into meaningful insights.

In an embodiment, inference module 612 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 612 transforms the outputs of a trained model into definitive classifications. Inference module 612 employs the underlying model as a tool to generate probabilistic outputs for each potential class. It then engages in an interpretative process to convert these probabilities into concrete class labels.

In an embodiment, when inference module 612 receives the probabilistic outputs from the model, it analyzes these probabilities to determine how they are distributed across some or every potential class. If the highest probability is not significantly greater than the others, inference module 612 may determine that there is ambiguity or interpret this as a lack of confidence displayed by the model.

In an embodiment, inference module 612 uses thresholding techniques for applications where making a definitive decision based on the highest probability might not suffice due to the critical nature of the decision. In such cases, inference module 612 assesses if the highest probability surpasses a certain confidence threshold that is predetermined based on the specific requirements of the application. If the probabilities do not meet this threshold, inference module 612 may flag the result as uncertain or defer the decision to a human expert. Inference module 612 dynamically adjusts the decision thresholds based on the sensitivity and specificity requirements of the application, subject to calibration for balancing the trade-offs between false positives and false negatives.

In accordance with an embodiment, inference module 612 contextualizes the probability distribution against the backdrop of the specific application. This involves a comparative analysis, especially in instances where multiple classes have similar probability scores, to deduce the most plausible classification. In an embodiment, inference module 612 may incorporate additional decision-making rules or contextual information to guide this analysis, ensuring that the classification aligns with the practical and contextual nuances of the application.

In regression models, where the outputs are continuous values, inference module 612 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 612 incorporates domain-specific adjustments into its post-processing routine. This involves tailoring the model's output to align with specific industry knowledge or contextual information. For example, in financial forecasting, inference module 612 may adjust predictions based on current market trends, economic indicators, or recent significant events, ensuring that the outputs are both statistically accurate and practically relevant.

In an embodiment, inference module 612 includes logic to handle uncertainty and ambiguity in the model's predictions. In cases where inference module 612 outputs a measure of uncertainty, such as in Bayesian inference models, inference module 612 interprets these uncertainty measures by converting probabilistic distributions or confidence intervals into a format that can be easily understood and acted upon. This provides users with both a prediction and an insight into the confidence level of that prediction. In an embodiment, inference module 612 includes mechanisms for involving human oversight or integrating the instance into a feedback loop for subsequent analysis and model refinement.

In an embodiment, inference module 612 formats the final predictions for end-user consumption. Predictions are converted into visualizations, user-friendly reports, or interactive interfaces. In some systems, like recommendation engines, inference module 612 also integrates feedback mechanisms, where user responses to the predictions are used to continually refine and improve the model, creating a dynamic, self-improving system.

FIG. 7 illustrates the operation of a machine learning engine in one or more embodiments. In an embodiment, input/output module 602 receives a dataset intended for training (Operation 701). This data can originate from diverse sources, like databases or real-time data streams, and in varied formats, such as CSV, JSON, or XML. Input/output module 602 assesses and validates the data, ensuring its integrity by checking for consistency, data ranges, and types.

In an embodiment, training data is passed to data preprocessing module 604. Here, the data undergoes a series of transformations to standardize and clean it, making it suitable for training ML models (Operation 702). This involves normalizing numerical data, encoding categorical variables, and handling missing values through techniques like imputation.

In an embodiment, prepared data from the data preprocessing module 604 is then fed into model selection module 606 (Operation 703). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 608 trains the selected model with the prepared dataset (Operation 704). It implements learning algorithms to adjust the model's internal parameters, optimizing them to identify patterns and relationships in the training data. Training module 608 also addresses the challenge of overfitting by implementing techniques, like regularization and early stopping, ensuring the model's generalizability.

In an embodiment, evaluation and tuning module 610 evaluates the trained model's performance using the validation dataset (Operation 705). Evaluation and tuning module 610 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 602 receives a dataset intended for inference. Input/output module 602 assesses and validates the data (Operation 706).

In an embodiment, data preprocessing module 604 receives the validated dataset intended for inference (Operation 707). Data preprocessing module 604 ensures that the data format used in training is replicated for the new inference data, maintaining consistency and accuracy for the model's predictions.

In an embodiment, inference module 612 processes the new data set intended for inference, using the trained and tuned model (Operation 708). It applies the model to this data, generating raw probabilistic outputs for predictions. Inference module 612 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 614 allows for applications to leverage machine learning engine 600. In an embodiment, machine learning engine API 614 may be built on a RESTful architecture and offer stateless interactions over standard HTTP/HTTPS protocols. Machine learning engine API 614 may feature a variety of endpoints, each tailored to a specific function within machine learning engine 600. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 614 is equipped to support SOAP-based interactions. This extension involves defining a WSDL (Web Services Description Language) document that outlines the API's operations and the structure of request and response messages. In an embodiment, machine learning engine API 614 supports various data formats and communication styles. In an embodiment, machine learning engine API 614 endpoints may handle requests in JSON format or any other suitable format. For example, machine learning engine API 614 may process XML, and it may also be engineered to handle more compact and efficient data formats, such as Protocol Buffers or Avro, for use in bandwidth-limited scenarios.

In an embodiment, machine learning engine API 614 is designed to integrate WebSocket technology for applications necessitating real-time data processing and immediate feedback. This integration enables a continuous, bi-directional communication channel for a dynamic and interactive data exchange between the application and machine learning engine 600.

### 5. Resource Management System

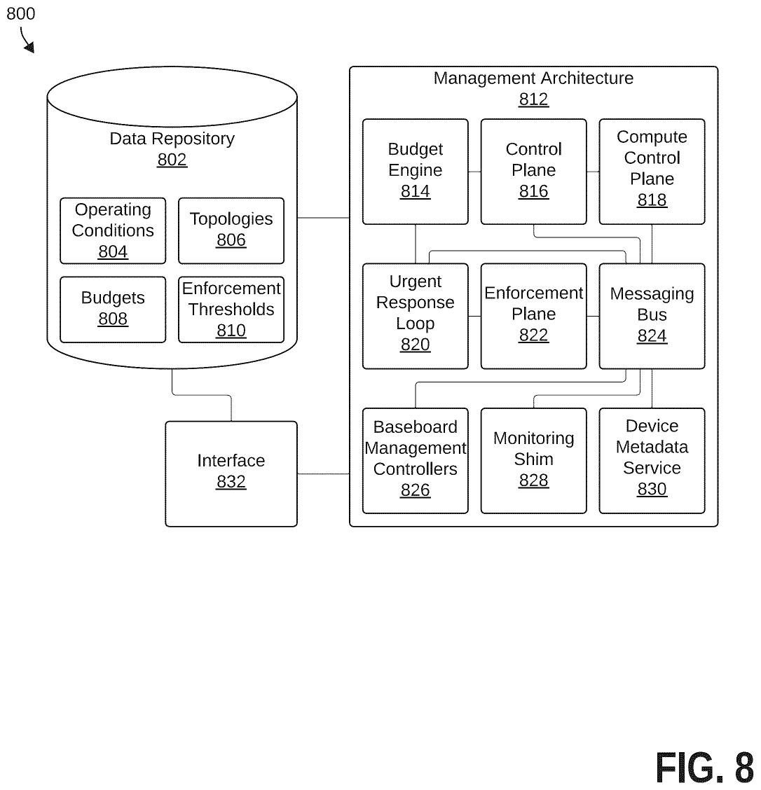

FIG. 8 illustrates a system 800 for resource management in accordance with one or more embodiments. As illustrated in FIG. 8, system 800 may include data repository 802, operating conditions 804, topologies 806, budgets 808, enforcement thresholds 810, management architecture 812, budget engine 814, control plane 816, compute control plane 818, urgent response loop 820, enforcement plane 822, messaging bus 824, baseboard management controllers (BMCs) 826, monitoring shim 828, device management service 830, and interface 832. In one or more embodiments, the system 800 may include more or fewer components than the components illustrated in FIG. 8. The components illustrated in FIG. 8 may be local to or remote from each other. The components illustrated in FIG. 8 may be implemented in software and/or hardware. Each component may be distributed over multiple applications and/or machines. Multiple components may be combined into one application and/or machine. Operations described with respect to one component may instead be performed by another component. Additional embodiments and/or examples relating to the management of resources are described by R01281NP and R01291NP. R01281NP and R01291NP are incorporated by reference in entirety as if set forth herein.

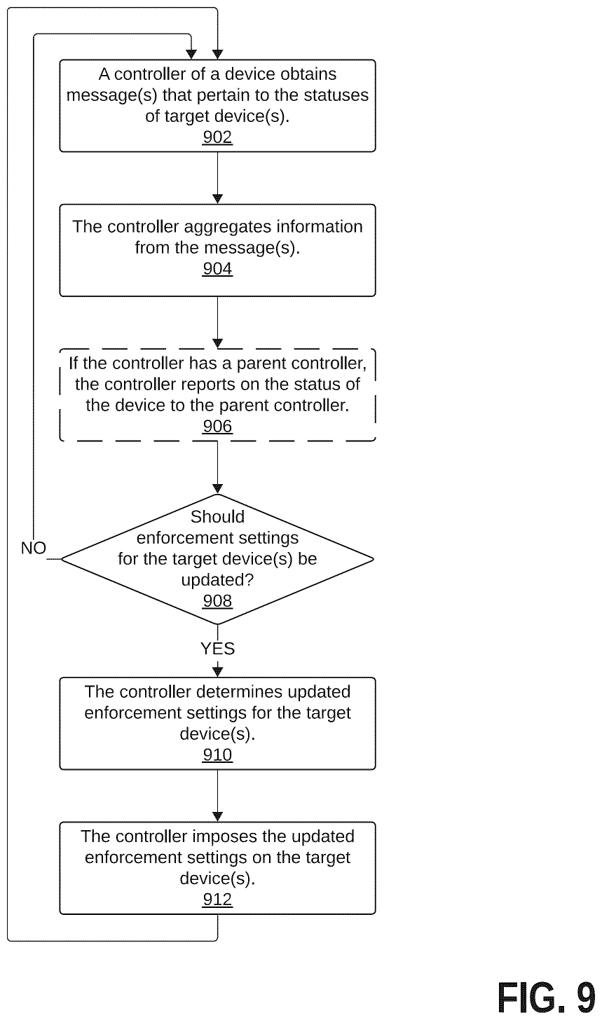

In an embodiment, system 800 refers to software and/or hardware configured to enforce budgeting. Example operations for enforcing a budget are described below with reference to FIG. 9.

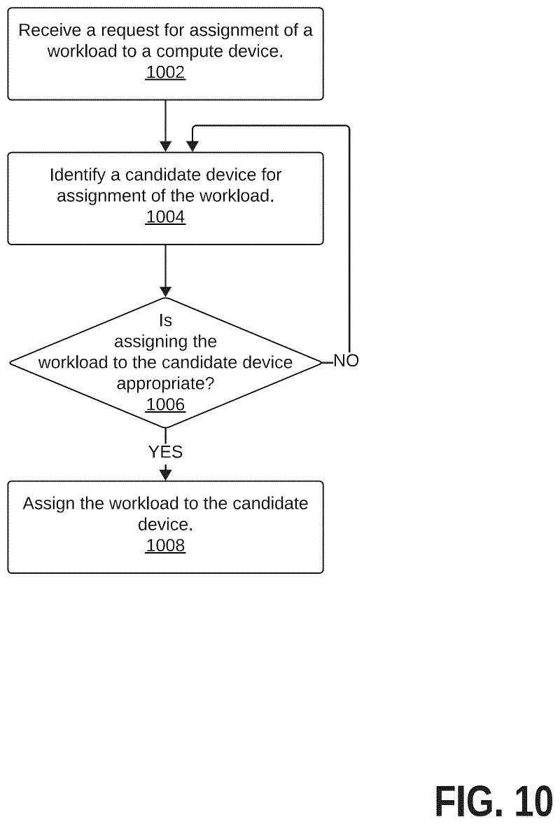

In an embodiment, system 800 refers to software and/or hardware configured to assign workloads. Example operations for assigning a workload are described below with reference to FIG. 10.

In an embodiment, techniques described herein for resource management are applied to devices of a data center. To provide consistent examples, a data center is used at multiple points in this Detailed Description as an example setting for application of the techniques described herein. However, application to devices of a data center is not essential or necessary to practice the techniques described herein. These examples are illustrations that are provided to aid in the reader's understanding. The techniques described herein are equally applicable to settings other than a data center and devices other than those that may be found in a data center.

In an embodiment, data repository 802 refers to any type of storage unit and/or device (e.g., a file system, database, collection of tables, or any other storage mechanism) for storing data. Furthermore, data repository 802 may include multiple different storage units and/or devices. The multiple different storage units and/or devices may or may not be of the same type or located at the same physical site. Furthermore, data repository 802 may be implemented or executed on the same computing system as other components of system 800. Additionally, or alternatively, data repository 802 may be implemented or executed on a computing system separate from other components of system 800. The data repository 802 may be communicatively coupled to other components of system 800 via a direct connection and/or via a network. As illustrated in FIG. 8, data repository 802 may include operating conditions 804, topologies 806, budgets 808, enforcement thresholds 810, and/or other information. The information illustrated within data repository 802 may be implemented across any of the components within system 800. However, this information is illustrated within data repository 802 for purposes of clarity and explanation.

In an embodiment, an operating condition 804 refers to information relevant to budgeting resources. For example, an operating condition 804 may be an attribute of a data center that is relevant to budgeting the utilization of resources by devices of the data center. Example operating conditions 804 of a data center include topological characteristics of the data center, characteristics of devices included in the data center, atmospheric conditions inside the data center, atmospheric conditions external to the data center, external limitations imposed on the data center, activity of data center operators, activity of data center users, historical patterns of activity regarding the data center, and other information that is relevant to budgeting in the data center.

In an embodiment, an operating condition 804 is a topological characteristic of a data center. As used herein, the term “topological characteristic” refers to any structural or organizational feature that defines the presence, arrangement, connectivity, and/or proximity between devices in a network of devices. For example, the topological characteristics of a data center may include the presence of devices in the data center and topological relationships between the devices in the data center. Example topological relationships include physical relationships, logical relationships, functional relations, and other relationships. A parent-child relationship between two devices is an example of a topological relationship.

In an embodiment, an operating condition 804 is a characteristic of a device included in a data center. For example, an operating condition 804 may be the status and/or capabilities of a physical device included in the data center. General examples of characteristics of a device that may be an operating condition 804 include the function of the device, specifications of the device, limitations of the device, the health of the device, the temperature of the device, resources that are utilized by the device, utilization of the device's resources, and other characteristics. An operating condition 804 may be a characteristic of a compute device, a power infrastructure device, an atmospheric regulation device, a network infrastructure device, a security device, a monitoring and management device, or another type of device. An operating condition 804 may be a characteristic of a device that includes a processor, and/or an operating condition 804 may be a characteristic of a device that does not include a processor. An operating condition 804 may be a characteristic of a software device, a hardware device, or a device that combines software and hardware. An operating condition 804 may be a characteristic of a device that is represented in a topology 806, and/or an operating condition 804 may be a characteristic of a device that is not represented in a topology 806.

In an embodiment, an operating condition 804 is a characteristic of a compute device included in a data center. As noted above, the term “compute device” refers to a device that provides computer resources (e.g., processing resources, memory resources, network resources, etc.) for computing activities (e.g., computing activities of data center users). Example compute devices that may be found in a data center include hosts (e.g., physical servers), racks of hosts, hyperconverged infrastructure nodes, AI/ML accelerators, edge computing devices, and others. A host is an example of a compute device because a host provides computer resources for computing activities of a user instance that is placed on the host. As used herein, the term “user instance” refers to an execution environment configured to perform computing tasks of a user (e.g., a user of a data center). Example user instances include containers, virtual machines, bare metal instances, dedicated hosts, and others.

In an embodiment, an operating condition 804 is a characteristic of a power infrastructure device included in a data center. As used herein, the term “power infrastructure device” refers to a device that is configured to generate, transmit, store, and/or regulate electricity. Example power infrastructure devices that may be included in a data center include generators, solar panels, wind turbines, transformers, inverters, rectifiers, switches, circuit breakers, transmission lines, uninterruptible power sources (UPSs), power distribution units (PDUs), busways, racks of hosts, rack power distribution units (rPDUs), battery storage systems, power cables, and other devices. Power infrastructure devices may be utilized to distribute electricity to compute devices in a data center. For instance, in a simplified example configuration of an electricity distribution network in a data center, UPS(s) may be used to distribute electricity to PDU(s), the PDU(s) may be used to distribute electricity to busways, the busways may be used to distribute electricity to racks of hosts, and rPDUs in the racks of hosts may be used to distribute electricity to the hosts in the racks. To provide consistent examples, the foregoing simplified example configuration of an electricity distribution network is used at multiple points in this Detailed Description. These examples are provided purely to aid in the reader's understanding. The techniques described herein are equally applicable to any other configuration of an electricity distribution network.

In an embodiment, an operating condition 804 is a characteristic of an atmospheric regulation device included in a data center. As used herein, term “atmospheric regulation device” refers to any device that is configured to regulate an atmospheric condition. As used herein, the term “atmospheric condition” refers to the actual or predicted state of an atmosphere at a specific time and location. Example atmospheric regulation devices include computer room air conditioning (CRAC) units, computer room air handler (CRAH) units, chillers, cooling towers, in-row cooling systems, expansion units, hot/cold aisle containment systems, heating, ventilation, and air conditioning (HVAC) systems, heat exchangers, heat pumps, humidifiers, dehumidifiers, liquid cooling systems, particulate filters, and others.

In an embodiment, an operating condition 804 is an external limitation imposed on a data center. With respect to a data center, the term “external limitation” is used herein to refer to a limitation imposed on the data center that does not derive from the current capabilities of the data center. An external limitation may impede a data center from operating at a normal operating capacity of the data center. For example, an external limitation may be imposed on the data center if the data center is capable of working at a normal operating capacity, but it is nonetheless impossible, impractical, and/or undesirable for the data center to operate at the normal operating capacity. Example external limitations that may be imposed on a data center include an insufficient supply of resources to the data center (e.g., electricity, fuel, coolant, data center operators, etc.), the cost of obtaining resources that are used to operate the data center (e.g., the price of electricity), an artificial restriction imposed on the data center (e.g., government regulations), and other limitations.

In an embodiment, an operating condition 804 is an atmospheric condition. An operating condition 804 may be an atmospheric condition external to a data center, and/or an operating condition 804 may be an atmospheric condition internal to the data center. An operating condition 804 may be an atmospheric condition of a particular environment within a data center such as a particular room of the data center. Examples of atmospheric conditions that may be operating conditions 804 include temperature, humidity, pressure, density, air quality, water quality, air currents, water currents, altitude, weather conditions, and others. An operating condition 804 may be a predicted atmospheric condition. For example, an operating condition 804 may be forecasted state of an atmosphere in a geographical region where a data center is situated at a specific time.

In an embodiment, an operating condition 804 is a characteristic of a device that is not represented in a topology 806. As an example, assume that a topology 806 maps an electricity distribution network of a data center. In this example, there may be various devices in a data center that it is not practical to monitor closely or represent in the topology 806 of the data center. Examples of devices that may not be represented in the topology 806 of this example include appliances (e.g., refrigerators, microwaves, etc.), personal devices (e.g., phones, laptops, etc.), chargers for personal devices, electric vehicles charging from an external outlet of a data center, HVAC systems for workspaces of data center operators, and various other devices. While it may be impractical to closely monitor these devices or represent these devices in the topology 806, measurements and/or estimates of the power that is being drawn by these devices in this example may nonetheless be relevant to budgeting in the data center.

In an embodiment, an operating condition 804 is user input. User input describing operating conditions 804 may be received via interface 832. In an example, an operating condition 804 is described by user input that is received from a data center operator. In this example, the user input may describe topological characteristics of the data center, an emergency condition occurring in the data center, planned maintenance of a device, or any other information that is relevant to budgeting.

In an embodiment, a topology 806 refers to a set of one or more topological characteristics of a network of devices. A topology 806 may be a physical topology, and/or a topology 806 may be a logical topology. A topology 806 may include elements that represent physical devices, and/or a topology 806 may include elements that represent virtual devices. A topology 806 may include links between elements that represent topological relationships between devices. Example topological relationships between devices that may be represented by links between elements of a topology 806 include physical relationships, logical relationships, functional relations, and other relationships. An example topology 806 maps a resource distribution network. In other words, the example topology 806 includes elements that represent devices and links that represent pathways for resource distribution to and/or from the devices.

In an embodiment, a topology 806 is a set of one or more topological characteristics of a data center. Example devices that may be represented by elements in a topology 806 of a data center include compute devices, virtual devices, power infrastructure devices, atmospheric regulation devices, network infrastructure devices, security devices, monitoring and management devices, and other devices that support the operation of the data center. Example topological relationships between devices that may be represented by links between elements in a topology 806 of a data center include power cables, coolant piping, wired network pathways, wireless network pathways, spatial proximity, shared support devices, structural connections, and other relationships.

In an embodiment, a topology 806 represents a hierarchy of parent-child relationships between devices. As noted above, the term “parent device” is used herein to refer to a device that (a) distributes resources to another device and/or (b) includes another device that is a subcomponent of the device, and the term “child device” is used herein to refer to a device that (a) is distributed resources through another device and/or (b) is a subcomponent of the other device. For example, a rack of hosts is considered a parent device to the hosts in the rack of hosts because (a) the hosts are subcomponents of the rack of hosts and/or (b) the rack of hosts may include one or more rPDUs that distribute electricity to the hosts in the rack. As another example, consider a busway that distributes electricity to a rack of hosts. In this other example, the busway is considered a parent device to the rack of hosts because the busway distributes a resource (i.e., electricity) to the rack of hosts. Note that a device may be indirectly linked to a child device of the device. For instance, a pathway for distributing resources from a device to a child device of the device may be intersected by one or more devices that are not represented in a topology 806. A device may simultaneously be a parent device and a child device. A device may possess multiple child devices, and the device may possess multiple parent devices. Two devices that share a common parent device may be referred to herein as “sibling devices.” As noted above, a device that directly or indirectly distributes resources to another device may be referred to herein as an “ancestor device” of the other device, and a device that is directly or indirectly distributed resources form another device is referred to herein as a “descendant device.” A parent device is an example of an ancestor device, and a child device is an example of a descendant device.

In an embodiment, a topology 806 represents a hierarchy of parent-child relationships between devices that maps to at least part of an electricity distribution network in a data center. As an example, consider a room of a data center that includes a UPS, multiple PDUs, multiple busways, and multiple racks of hosts. In this example, the UPS distributes electricity to the multiple PDUs, the multiple PDUs distribute electricity to the multiple busways, and the multiple busways distribute electricity to the multiple racks of hosts. The electricity that is distributed to the racks of hosts in this example is consumed by the hosts in the multiple racks of hosts. A corresponding topology 806 in this example may present a hierarchy of parent-child relationships where the UPS is situated at the top of the hierarchy and the racks of hosts are situated at the bottom of the hierarchy. In particular, the topology 806 of this example presents the UPS as a parent device to the multiple PDUs, and the topology 806 presents a PDU as a parent device to the busways that are distributed electricity through that PDU. Furthermore, the topology 806 of this example represents a busway as a parent device to the racks of hosts that are distributed electricity through that busway.

In an embodiment, a budget 808 refers to one or more defined allocations of resources. An allocation of a resource in a budget 808 may be a hard limit on the utilization of that resource, and/or an allocation of a resource in a budget 808 may be a soft limit on the utilization of that resource. Examples of resources that may be allocated by a budget 808 include energy resources, computer resources, capital resources, administrative resources, and other resources. An allocation of a resource in a budget 808 may define a quantity of that resource that can be utilized. Additionally, or alternatively, a budget 808 may include restrictions other than a quantified allocation of resources. For example, a budget 808 may restrict what a resource can be utilized for, for whom resources can be utilized, when a resource can be utilized, and/or other aspects of a resource's utilization. A restriction that is defined by a budget 808 is referred to herein as a “budget constraint.” An example budget 808 may include a hard budget constraint that cannot be exceeded, and/or the example budget 808 may include a soft budget constraint. If the soft budget constraint of the example budget 808 is exceeded, the system 800 may conclude that the hard budget constraint is at risk of being exceeded. Exceeding either the soft budget constraint or the hard budget constraint of the example budget 808 may trigger the imposition of enforcement thresholds 810 on descendant devices.

In an embodiment, a budget 808 is a set of one or more budget constraints that are applicable to a device. For example, a budget 808 may be a set of budget constraint(s) that are applicable to a specific device in a data center. A budget 808 may be applicable to a single device, and/or a budget 808 may be applicable to multiple devices. A budget 808 may be applicable to a parent device, and/or a budget 808 may be applicable to a child device. A budget 808 for a device may include power restrictions, thermal restrictions, network restrictions, use restrictions, and/or other restrictions. As used herein, the term “power restriction” refers to a restriction relating to the utilization of energy. For instance, a power restriction may restrict the utilization of electricity. Example power restrictions include maximum instantaneous power draws, maximum average power draws, load ratios for child devices, power allocation priorities, power throttling thresholds, redundancy power limits, restrictions on fuel consumption, carbon credits, and other restrictions. It should be understood that a power restriction need not be specified in a unit of power. As used herein, the term “thermal restriction” refers to a restriction relating to heat transfer. Example thermal restrictions include maximum operating temperatures, restrictions on heat output, restrictions on coolant consumption, and other restrictions. As used herein, the term “coolant” refers to a substance that is configured to induce heat transfer. An example coolant is a fluid (e.g., a liquid or gas) that removes heat from a device or an environment. As used herein, the term “network restriction” refers to a restriction relating to the utilization of a network resource. Example network restrictions include a permissible inbound bandwidth, a maximum permissible outbound bandwidth for the device, a maximum permissible aggregate bandwidth, and other restrictions. As used herein, the term “use restriction” refers to a restriction relating to how the computer resources (e.g., processing resource, memory resources, etc.) of a device may be utilized. Example use restrictions include a maximum CPU utilization level, a maximum GPU utilization level, a maximum number of processing threads, restrictions on memory usage, limits on storage access or Input/Output Operations Per Second (IOPS), restrictions on virtual machine or container provisioning, and other restrictions.

In an embodiment, a budget 808 for a device is a conditional budget. As used herein, the term “conditional budget” refers to a budget 808 that is applied if one or more trigger conditions associated with the conditional budget are satisfied. In an example, a conditional budget 808 is tailored to a potential occurrence in a data center, such as a failure of a device in the data center (e.g., a compute device, a power infrastructure device, an atmospheric regulation device, etc.), a significant temperature rise in the data center, an emergency command from a data center operator, and/or other abnormal operating conditions 804.

In an embodiment, an enforcement threshold 810 refers to a restriction that is used to implement budgeting or respond to an emergency condition. An example enforcement threshold 810 is a hard limit on the amount of resources that can be utilized by a device. An enforcement threshold 810 may include power restrictions, thermal restrictions, network restrictions, use restrictions, and/or other types of restrictions. As used herein, an enforcement threshold 810 that includes a power restriction is referred to as a “power cap threshold.”

In an embodiment, an enforcement threshold 810 is a restriction that is imposed on a descendant device to implement a budget constraint or enforcement threshold 810 that is applicable to an ancestor device. As an example, assume that a budget 808 assigned to a rack of hosts limits the power that may be drawn by the rack of hosts. In this example, the budget 808 assigned to the rack of hosts may be implemented by imposing power cap thresholds on the individual hosts in the rack of hosts. The utilization of a resource by a device may be simultaneously restricted by a budget 808 assigned to the device and an enforcement threshold 810 imposed on the device. An enforcement threshold 810 that limits the utilization of a resource by a device may be more stringent than a budget constraint assigned to the device that limits the utilization of that same resource. Therefore, an enforcement threshold 810 imposed on a device that limits the utilization of a resource by the device may effectively supersede a budget constraint assigned to the device that also restricts the utilization of that resource until the enforcement threshold 810 is lifted.

In an embodiment, management architecture 812 refers to software and/or hardware configured to manage resource utilization. As illustrated in FIG. 8, management architecture 812 may include budget engine 814, control plane 816, compute control plane 818, urgent response loop 820, enforcement plane 822, messaging bus 824, BMCs 826, monitoring shim 828, device metadata service 830, and/or other components. Management architecture 812 may include more or fewer components than the components illustrated in FIG. 8. Operations described with respect to one component of management architecture 812 may instead be performed by another component of management architecture 812. A component of management architecture 812 may be implemented or executed on the same computing system as other components of system 800, and/or a component of management architecture 812 may be implemented on a computing system separate from other components of system 800. A component of management architecture 812 may be communicatively coupled to other components of system 800 via a direct connection and/or via a network.

In an embodiment, budget engine 814 refers to software and/or hardware configured to generate budgets 808. Budget engine 814 is configured to autonomously generate budgets 808, and/or budget engine 814 is configured to generate budgets 808 in collaboration with a user of system 800. Budget engine 814 is configured to generate budgets 808 based on operating conditions 804, topologies 806, and/or other information. Budget engine 814 is configured to dynamically update budgets 808 in response to determining an actual or predicted change to operating conditions 804 and/or topologies 806. Budget engine 814 is configured to communicate with other components of system 800, components external to system 800, and/or users of system 800 via messaging bus 824, API(s), and/or other means of communication. Budget engine 814 may be configured to communicate with a user of system 800 via interface 832.

In an embodiment, budget engine 814 is configured to generate budgets 808 for devices in a data center. Budget engine 814 may be configured to generate budgets 808 for hardware devices, software devices, and/or devices that combine software and hardware. General examples of devices that budget engine 814 may generate budgets 808 for include the following: compute devices, virtual devices, power infrastructure devices, atmospheric regulation devices, network infrastructure devices, security devices, monitoring and management devices, and other devices that support the operation of a data center.

In an embodiment, budget engine 814 is configured to monitor topological characteristics of a data center, and budget engine 814 is configured to maintain one or more topologies 806 of the data center. In this embodiment, budget engine 814 is further configured to generate budgets 808 for devices represented in a topology 806 of the data center. As an example, assume that a topology 806 of a data center reflects an electricity distribution network of the data center at least in part. For instance, the topology 806 of the data center in this example might indicate that a UPS distributes electricity to multiple PDUs, the multiple PDUs distribute electricity to multiple busways, the multiple busways distribute electricity to multiple racks of hosts, and rPDUs embedded in the racks of hosts distribute electricity to the hosts in the racks. In this example, budget engine 814 may be configured to generate individual budgets 808 for the UPS, the PDUs, the busways, the racks of hosts, the rPDUs in the racks of hosts, and/or the hosts. In general, the devices in a data center that are represented in a topology 806 of the data center and assigned individual budgets 808 by budget engine 814 may vary depending on the level of granularity that is needed for budgeting in the data center. For instance, in one example, a lowest-level device to be assigned a budget 808 by budget engine 814 may be a rack of hosts, and in another example, a lowest-level device to be assigned a budget-by-budget engine 814 may be a busway.

In an embodiment, budget engine 814 is configured to dynamically update a topology 806 of a data center in response to detecting a change to a topological characteristic of the data center. For example, budget engine 814 may be configured to dynamically update a topology 806 of a data center in response to detecting the presence of a new device in the data center, the absence of a previously detected device in the data center, a change to the manner that resources are distributed to devices in the data center, and other changes to topological characteristics of the data center.

In an embodiment, budget engine 814 is configured to dynamically update budgeting in a data center in response to determining an actual or predicted change to the operating conditions 804 of a data center. For example, budget engine 814 may be configured to generate updated budgets 808 for devices in a data center in response to determining an actual or predicted change to topological characteristics of the data center, characteristics of devices included in the data center, atmospheric conditions inside the data center, atmospheric conditions external to the data center, external limitations imposed on the data center, and/or other operating conditions 804.

In an embodiment, budget engine 814 is configured to generate budgets 808 for devices by applying one or more trained machine learning models to the operating conditions 804 of a data center. Example training data that may be used to train a machine learning model to predict a change in the operating conditions 804 of a data center includes historical operating conditions 804 of the data center, historical operating conditions 804 of other data centers, theoretical operating conditions 804 of the data center, and/or other training data. An example set of training data may define an association between (a) a set of operating conditions 804 in a data center (e.g., topological characteristics of the data center, characteristics of individual devices, atmospheric conditions, etc.) and (b) a set of budgets 808 that are to applied in that set of operating conditions 804. A machine learning model applied to generate budgets 808 for devices in a data center may be trained further based on feedback pertaining to budgets 808 generated by the machine learning model.

In an embodiment, budget engine 814 is configured to predict a change to operating conditions 804, and budget engine 814 is configured to generate budget(s) 808 based on the predicted change. Example inputs that may be a basis for budget engine 814 predicting a change to the operating conditions 804 of a data center include a current trend in the operating conditions 804 of the data center, historical patterns in the operating conditions 804 of the data center, input from data center operators, and other information. Example occurrences that may be predicted by budget engine 814 include a failure of a device, maintenance of a device, a change in atmospheric conditions within the data center, a change in atmospheric conditions external to the data center, an increase or decrease in the workloads imposed on devices in the data center, and other occurrences.

In an embodiment, budget engine 814 is configured to predict a change in the operating conditions 804 of a data center by applying one or more trained machine learning models to the operating conditions 804 of the data center. Example training data that may be used to train a machine learning model to predict a change in the operating conditions 804 of the data center include historical operating conditions 804 of the data center, historical operating conditions 804 of other data centers, theoretical operating conditions 804 of the data center, and/or other training data. A machine learning model may be further trained to predict changes in a data center based on feedback pertaining to predictions output by the machine learning model. In an example, a machine learning model is trained to predict a failure of a device in a data center. In this example, a set of training data used to train the machine learning model may define an association between (a) a failure of a device in a data center and (b) one or more operating conditions 804 of the data center that are related to the failure of the device. If an application of the machine learning model outputs a predicted failure of a device in this example, budget engine 814 is configured to (a) generate new budget(s) that are formulated to reduce the risk of the predicted failure occurring and/or (b) generate new budget(s) that are to be applied in the event of the predicted failure occurring (i.e., conditional budget(s) 808). In another example, a machine learning model is trained to predict the inability of atmospheric regulation devices to maintain normal operating conditions 804 in a data center.

In an embodiment, budget engine 814 leverages one or more machine learning algorithms that are tasked with training one or more machine learning models to predict changes to operating conditions 804 of a data center and/or generate budgets 808 for devices in a data center. A machine learning algorithm is an algorithm that can be iterated to train a target model that best maps a set of input variables to an output variable using a set of training data. The training data includes datasets and associated labels. The datasets are associated with input variables for the target model. The associated labels are associated with the output variable of the target model. The training data may be updated based on, for example, feedback on the predictions by the target model and accuracy of the current target model. Updated training data is fed back into the machine learning algorithm that in turn updates the target model. A machine learning algorithm generates a target model such that the target model best fits the datasets of training data to the labels of the training data. Additionally, or alternatively, a machine learning algorithm generates a target model such that when the target model is applied to the datasets of the training data, a maximum number of results determined by the target model matches the labels of the training data. Different target models be generated based on different machine learning algorithms and/or different sets of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering. Additional embodiments and/or examples related to machine learning techniques that may be incorporated by system 800 and leveraged by budget engine 814 are described above in Section 4 titled “Machine Learning Architecture.”

In an embodiment, budget engine 814 is configured to communicate operating conditions 804, topologies 806, budgets 808, and/or other information to one or more other components of system 800. For instance, budget engine 814 may be configured to communicate operating conditions 804, topologies 806, budgets 808, and/or other information to control plane 816, urgent response loop 820, and/or other components of the system. In an example, budget engine 814 presents an API that can be leveraged to pull operating conditions 804, topologies 806, budgets 808, and/or other information from budget engine 814. In another example, budget 814 leverages an API to push operating conditions 804, topologies 806, budgets 808, and/or other information to other components of system 800. In yet another example, budget engine 814 is configured to communicate operating conditions 804, topologies 806, budgets 808, and/or other information via messaging bus 824.

In an embodiment, control plane 816 refers to software and/or hardware configured to collect, process, and/or distribute information that is relevant to resource management. Control plane 816 is configured to collect information from other components of system 800, users of system 800, and/or other sources of information. Control plane 816 is configured to distribute information to other components of system 800, users of system 800, and/or other recipients. Control plane 816 is configured to obtain and/or distribute information via messaging bus 824, one or more APIs, and/or other means of communication. Control plane 816 may be configured to communicate with a user of system 800 via interface 832.

In an embodiment, control plane 816 is a layer of management architecture 812 that is configured to collect, process, and/or distribute information that is relevant to managing the utilization of resources by devices in a data center. Example information that may be collected, processed, and/or distributed by control plane 816 includes operating conditions 804, topologies 806, budgets 808, compute metadata, user input, and other information.

In an embodiment, control plane 816 is configured to collect, process, and/or distribute operating conditions 804, topologies 806, budgets 808, and/or other information. Control plane 816 is configured to collect operating conditions 804, topologies 806, budgets 808, and/or other information from budget engine 814, and/or other sources of information. Control plane 816 is configured to selectively communicate operating conditions 804, topologies 806, budgets 808, and/or other information to enforcement plane 822, and/or other recipients. In an example, control plane 816 is configured to collect operating conditions 804, topologies 806, budgets 808, and/or other information associated with devices in a data center by leveraging an API that allows control plane 816 to pull information from budget engine 814. In this example, control plane 816 is further configured to distribute the operating conditions 804, topologies 806, budgets 808, and/or other information associated with the devices in the data center to components of enforcement plane 822 that manage those devices by selectively publishing this information to messaging bus 824.

In an embodiment, control plane 816 is configured to collect, process, and distribute compute metadata and/or other information. As used herein, the term “compute metadata” refers to information associated with compute devices and/or compute workloads. Example compute metadata includes metadata of user instances placed on compute devices (referred to herein as “user instance metadata”), metadata of compute devices hosting user instances (referred to herein as “compute device metadata”), and other information. Compute metadata collected by control plane 816 may originate from compute control plane 818, device metadata service 830, and/or other sources of information. Control plane 816 is configured to process compute metadata to generate metadata that can be used as a basis for budget implementation determinations (referred to herein as “enforcement metadata”). Control plane 816 is configured to selectively communicate compute metadata, enforcement metadata, and/or other information to enforcement mechanisms of enforcement plane 822 and/or other recipients. In an example, control plane 816 is configured to monitor messaging bus 824 for compute metadata that is published to messaging bus 824 by compute control plane 818 and/or device metadata service 830. Based on compute metadata obtained by control plane 816 from messaging bus 824 in this example, control plane 816 is configured to generate enforcement metadata, and control plane 816 is configured to distribute the compute metadata, enforcement metadata, and/or other information to enforcement mechanisms of enforcement plane 822 by selectively publishing this information to messaging bus 824.

In an embodiment, compute control plane 818 refers to software and/or hardware configured to manage the workloads of compute devices. Compute control plane 818 is configured to communicate with other components of system 800, components external to system 800, and/or users of system 800 via messaging bus 824, API(s), and/or other means of communication. Compute control plane 818 may be configured to communicate with a user of system 800 via interface 832.

In an embodiment, compute control plane 818 is a layer of management architecture 812 configured to manage user instances that are placed on hosts of a data center. For instance, compute control plane 818 may be configured to provision user instances, place user instances, manage the lifecycle of user instances, track the performance and health of user instances, enforce isolation between user instances, manage compute metadata, and perform various other functions.

In an embodiment, compute control plane 818 is configured to selectively place user instances on compute devices of a data center. In an example, compute control plane 818 is configured to select a compute device for placement of a user instance based on characteristics of the compute device, characteristics of related devices (e.g., ancestors, siblings, etc.), budgets 808 assigned to the compute device, budgets 808 assigned to related devices, enforcement thresholds 810 imposed on the device, enforcement thresholds 810 imposed on related devices, compute metadata associated with the compute device, operating conditions 804, and/or other inputs.

In an embodiment, compute control plane 818 is configured to place a user instance on a compute device based on a predicted impact of placing the user instance on the compute device. For example, if a predicted impact of placing a user instance on a host is not expected to result in the exceeding of any restrictions associated with the host, compute control plane 818 may be configured to select that host for placement. Example restrictions that may influence the placement of user instances on compute devices by compute control plane 818 include budget constraints, enforcement thresholds 810, hardware and/or software limitations of the compute devices, hardware limitations of power infrastructure devices that support the compute devices (e.g., a trip setting of a circuit breaker), hardware limitations of atmospheric regulation devices that support the compute devices, hardware and/or software limitations of network infrastructure devices that support the compute devices, and various other restrictions. A restriction associated with a compute device is specific to the compute device, or the restriction associated with the compute device is not specific to the compute device. Examples restrictions that may be specific to a compute device include a budget 808 assigned to the compute device, enforcement thresholds 810 imposed on the compute device, hardware constraints of the compute device, and others. Example restrictions that are typically not specific to any one compute device include a budget 808 assigned to an ancestor device of the compute device, an enforcement threshold 810 assigned to an ancestor device of the compute device, a trip setting of a circuit breaker that regulates electricity distribution to the compute device, a cooling capacity of an atmospheric regulation device that regulates an environment (e.g., a room of a data center) that includes the compute device, and other restrictions.

In an embodiment, compute control plane 818 is configured to determine an actual or predicted impact of assigning a user instance to a host by applying one or more trained machine learning models to characteristics of the user instance, characteristics of a user associated with the user instance, characteristics of the host, characteristics of ancestor devices of the host, characteristics of other devices that support the operation of the host (e.g., atmospheric regulation devices, network infrastructure devices, etc.), and/or other information. Additional embodiments and/or examples related to machine learning techniques that may be incorporated by system 800 and leveraged by compute control plane 818 are described above in Section 4 titled “Machine Learning Architecture.”

In an embodiment, compute control plane 818 is configured to serve as a mechanism for enacting budgets 808 and enforcement thresholds 810 by preventing additional workloads from being assigned to compute devices. For example, compute control plane 818 may prevent new user instances being placed on compute devices to reduce the resource consumption of the compute devices. By reducing the resource consumption of compute devices, compute control plane 818 reduces the resources that are drawn by ancestor devices of the compute devices. In this way, compute control plane 818 may serve as a mechanism for enacting budgets 808 and enforcement thresholds 810 of child devices and parent devices. A compute device is referred to herein as being “closed” if placing additional user instances on the compute device is currently prohibited, and the compute device is referred to herein as being “open” if placing additional user instances on the compute device is not currently prohibited. An ancestor device (e.g., a power infrastructure device) is referred to herein as being “closed” if placing additional user instances on compute devices that are descendant devices of the ancestor device is currently prohibited, and the ancestor device is referred to herein as being “open” if placing additional user instances on compute devices that are descendant devices of the ancestor device is not currently prohibited. As an example, assume that a busway distributes energy to multiple racks of hosts. If the busway is closed to placement in this example, no additional user instances can be placed on the hosts in the multiple racks of hosts unless the busway is subsequently reopened.

In an embodiment, compute control plane 818 is configured to communicate compute metadata to budget engine 814 and/or other components of system. In an example, compute control plane 818 is configured to communicate compute metadata to budget engine 814 by publishing the compute metadata to messaging bus 824. In this example, compute control plane 818 is configured to publish updated compute metadata to messaging bus 824 when a user instance is launched, updated, or terminated.

In an embodiment, urgent response loop 820 refers to software and/or hardware configured to (a) monitor devices for emergency conditions and (b) trigger responses to emergency conditions. For example, urgent response loop 820 may be configured to trigger the implementation of emergency restrictions on resource utilization in response to detecting an emergency condition. In general, urgent response loop 820 may act as a mechanism for rapidly responding to an emergency condition until a more comprehensive response is formulated by other components of the system, and/or the emergency condition ceases to exist. Urgent response loop 820 is configured to communicate with other components of system 800, components external to system 800, and/or users of system 800 via messaging bus 824, API(s), and/or other means of communication. Urgent response loop 820 may be configured to communicate with a user of system 800 via interface 832.

In an embodiment, urgent response loop 820 is configured to implement urgent restrictions on resource utilization in response to detecting an emergency condition in a data center. Urgent response loop 820 is configured to communicate commands for restricting resource utilization to enforcement plane 822 and/or other recipients. Restrictions imposed by urgent response loop 820 may remain in effect until budget engine 814 and/or other components of the system 800 (e.g., budget engine 814) have developed a better understanding of current operating conditions 804 and can generate budgets 808 that are better tailored to responding to the situation. In an example, urgent response loop 820 is configured to implement emergency power capping on devices of a data center in response to detecting an emergency condition in the data center. Urgent response loop 820 may be configured to implement budgets 808 (e.g., conditional budgets 808), enforcement thresholds 810, and/or other types of restrictions. Example conditions that may result in urgent response loop 820 imposing restrictions on devices include a failure of a device in the data center (e.g., a compute device, a power infrastructure device, an atmospheric regulation device, etc.), a significant change in electricity consumption, a significant change in electricity supply, a significant change in temperature, a command from a user of system 800, and other conditions.

In an embodiment, urgent response loop 820 is configured to implement a one-deep-cut policy in response to an emergency operating condition 804. An example one-deep-cut policy dictates that maximum enforcement thresholds 810 are imposed on each of the devices in a topology 808 of a data center. Another example one-deep-cut policy dictates that maximum enforcement thresholds 810 are imposed on a subset of the devices that are represented in a topology 808 of a data center. An example maximum enforcement threshold 810 for a device limits the resource consumption of the device to a lowest value that can be sustained while the device remains operational for the device's intended purpose.

In an embodiment, enforcement plane 822 refers to software and/or hardware configured to manage the implementation of restrictions on resource utilization. Internal communications within enforcement plane 822 may be facilitated by messaging bus 824 and/or other means of communication. Enforcement plane 822 is configured to communicate with other components of system 800, components external to system 800, and/or users of system 800 via messaging bus 824, API(s), and/or other means of communication. Enforcement plane 822 may be configured to communicate with a user of system 800 via interface 832.

In an embodiment, enforcement plane 822 is configured to determine enforcement thresholds 810 that can be used to implement restrictions that are applicable to devices. Enforcement plane 822 may implement a restriction that is applicable to one device by determining enforcement threshold(s) 810 for other device(s). For instance, enforcement plane 822 is configured to implement a budget 808 assigned to a device by determining enforcement threshold(s) 810 for child device(s) of the device. In an example, enforcement plane 822 implements a power-based budget constraint assigned to a PDU by imposing power cap thresholds on busways that are distributed electricity from the PDU. Enforcement plane 822 is further configured to implement an enforcement threshold 810 that is imposed on a device by determining enforcement threshold(s) 810 for child device(s) of the device. For example, enforcement plane 822 may implement a power cap threshold imposed on a busway by determining additional power cap thresholds for racks of hosts that are distributed electricity from the busway. Furthermore, in this example, enforcement plane 822 may implement a power cap threshold imposed on a rack of hosts by determining power cap thresholds for hosts that are included in the rack of hosts. Ultimately, enforcement thresholds 810 imposed on devices by enforcement plane 822 are enforced by enforcement mechanisms of system 800 that limit the activity of those devices. The manner that an enforcement threshold 810 should be enforced on a device may be defined in the enforcement threshold 810 by enforcement plane 822. Example enforcement mechanisms that may be leveraged by enforcement plane 822 to enforce an enforcement threshold 810 include compute control plane 818, BMCs 826, a user instance controller operating at a hypervisor level of compute devices, an enforcement agent executing in a computer system of a data center user, and other enforcement mechanisms.

In an embodiment, enforcement plane 822 is configured to instruct a BMC 826 of a compute device to enact an enforcement thresholds 810 that is imposed by enforcement plane 822 on the compute device. By enacting an enforcement threshold 810 imposed on a compute device, a BMC of the compute device may contribute to bringing ancestor devices of the compute device into compliance with budgets 808 and/or enforcement thresholds 810 that are applicable to the ancestor devices.

In an embodiment, enforcement plane 822 is configured to instruct compute control plane 818 to enforce an enforcement threshold 810 that has been imposed on the device. In an example, enforcement plane 822 instructs compute control plane 818 to enforce a power cap threshold imposed on a host by closing that host. As a result, additional user instances cannot subsequently be placed on the host while the host remains closed, and the power consumption of the host may be reduced in this example. In another example, enforcement plane 822 instructs compute control plane 818 to enforce a power cap threshold imposed on a power infrastructure device (e.g., a UPS, a busway, a PDU, etc.) by closing the power infrastructure device. As a result, additional user instances cannot be placed on compute devices that are distributed electricity through the power infrastructure device, and the power draw of the power infrastructure device may be reduced in this other example.

In an embodiment, enforcement plane 822 is configured to instruct a user instance controller to restrict the activity of a user instance that is placed on a compute device. Enforcement plane 822 may be configured to instruct a user instance controller indirectly through compute control plane 818. In an example, enforcement plane 822 is configured to instruct a VM controller residing at a hypervisor level of a host to enforce a power cap threshold imposed on the host by limiting the activity of a user instance placed on the host. Directing a user instance controller to limit the activity of user instances may serve as a mechanism for fine-grain enforcement of budgets 808, enforcement thresholds 810, and/or other restrictions. For instance, a user instance controller may be configured to implement an enforcement threshold 810 in a manner that limits the impact to a subset of users.

In an embodiment, enforcement plane 822 is configured to instruct an enforcement agent executing on a computer system of a user to restrict the activity of user instances that are owned by that user. For example, enforcement plane 822 may instruct an agent executing on a computer system of a data center user to enforce an enforcement threshold 810 imposed on a host by limiting the activities of a user instance placed on the host that is owned by the data center user. Instructing an agent executing on a computer system of a user may serve as a mechanism for fine-grain enforcement of budgets 808, enforcement thresholds 810, and/or other restrictions.

In an embodiment, enforcement plane 822 includes one or more controllers. As used herein, the term “controller” refers to software and/or hardware configured to manage a device. An example controller is a logical control loop that is configured to manage a device represented in a topology 806 of a data center. A device managed by a controller may be a parent device and/or a child device. Enforcement plane 822 may include a hierarchy of controllers that corresponds to a hierarchy of parent-child relationships between devices represented in a topology 806 of a data center. As used herein, the term “parent controller” refers to a controller that possesses at least one child controller, and the term “child controller” refers to a controller that possesses at least one parent controller. Note that a device managed by a controller is not necessarily a parent device to a device that is managed by a child controller of the controller. For example, a device managed by a controller may be a distant ancestor device to a device that is managed by a child controller of the controller.

In an embodiment, a controller of enforcement plane 822 is a parent controller, or the controller is a leaf-level controller. As used herein, the term “leaf-level controller” refers to a controller residing in the lowest level of a hierarchy of controllers. In other words, a leaf-level controller is a controller that has no child controllers in a hierarchy of controllers spawned within enforcement plane 822 to manage a network of devices. The term “leaf-level device” is used herein to identify a device managed by a leaf-level controller. Note that while a leaf-level controller is not a parent controller, a leaf-level device may be a parent device. For instance, in the example context of an electricity distribution network, a leaf-level device may be a UPS that distributes electricity to PDUs, a PDU that distributes electricity to busways, a busway that distributes electricity to racks of hosts, a rack of hosts that include rPDUs that distribute electricity to the hosts in a rack, or any other parent device that may be found in the electricity distribution network. In general, the type of devices in a data center that are managed by leaf-level controllers may vary depending on the level of granularity that is appropriate for budgeting in the data center. As used herein, the term “rPDU controller” may be used to identify a controller of an rPDU, the term “rack controller” may be used to identify a controller of a rack of hosts, the term “busway controller” may be used to identify a controller of a busway, the term “PDU controller” may be used to identify a controller of a PDU, and the term “UPS controller” may be used to identify a controller of a UPS.

In an embodiment, a controller (e.g., a parent controller or a leaf-level controller) spawned in enforcement plane 822 to manage a device is configured to monitor the status of the device. To this end, a controller of a device may be configured to monitor the resources that are being utilized by the device, the health of the device, the temperature of the device, the occupancy of the device, enforcement thresholds 810 that are currently imposed on the device, theoretical enforcement thresholds 810 that could be imposed on the device, and/or other information pertaining to the status of the device. A controller of a device may obtain information pertaining to the status of the device by aggregating information that is pertinent to the status of the device's descendant devices. For example, a controller of a rack of hosts may determine the power that is being drawn by the rack of hosts by aggregating power consumption measurements of individual hosts in the rack of hosts. If a controller of a device is a parent controller, the controller may obtain measurements of the resources that are being utilized by the device's ancestor devices (e.g., child devices and/or further descendant devices) from the controller's child controllers. If a controller of a device is a leaf-level controller, the controller may obtain measurements of resources that are being utilized by the device's ancestor devices of the device from BMCs of the ancestor devices. By determining the aggregate resource consumption of a device's descendant devices, a controller of the device may discern if the device is exceeding or at risk of exceeding any restrictions that are applicable to the device. If a controller of a device possesses a parent controller of a parent device, the controller may be configured to report the aggregate resource consumption of the device's descendant devices to the parent controller so that the parent controller can, in turn, determine the aggregate resource consumption of the parent device's descendant devices. As an example, consider a busway that distributes electricity to multiple racks of hosts. In this example, a controller of the busway determines the aggregate power that is drawn by the busway based on individual power draw values reported to the busway controller by the controllers of the multiple racks of hosts. If the busway controller possesses a parent controller in enforcement plane 822 in this example, the busway controller is configured to report the aggregate power draw of the busway to the parent controller. For instance, if the busway is distributed electricity through a PDU in this example, the busway controller may report the aggregate power draw of the busway to a controller of the PDU so that the PDU controller can determine the aggregate power draw of the PDU. Communications between controllers are facilitated by messaging bus 824 and/or other means of communication.

In an embodiment, a controller (e.g., a parent controller or a leaf-level controller) spawned in enforcement plane 822 to manage a device is configured to implement budgets 808 assigned to the device. A controller of a device (e.g., a UPS, a PDU, a busway, a rack of hosts, an rPDU, etc.) is configured to implement a budget 808 assigned to the device by determining enforcement thresholds 810 to impose on child devices. A controller of a device is configured to determine enforcement thresholds 810 for child devices based on information reported by child controllers, information reported by BMCs, enforcement metadata, and/or other information. A controller of a device is configured to communicate enforcement thresholds 810 to child controllers of child devices via messaging bus 824 and/or other means of communication.

In an embodiment, a controller (e.g., a parent controller or a leaf-level controller) spawned in enforcement plane 822 to manage a device is configured to implement enforcement thresholds 810 imposed on the device. A controller of a device is configured to implement an enforcement threshold 810 assigned to the device by determining enforcement threshold 810 to impose on child devices. A controller of device is configured to determine enforcement thresholds 810 for child devices based on information reported by BMCs, information reported by child controllers, enforcement metadata, and/or other information. A controller of a device is configured to communicate enforcement thresholds 810 to child controllers of child devices via messaging bus 824 and/or other means of communication.

In an embodiment, a controller (e.g., a parent controller or a leaf-level controller) included in enforcement plane 822 is configured to generate heartbeat communications. As used herein, the term “heartbeat communication” refers to a message indicating the health and/or state of a controller. In an example, a controller is configured to periodically generate heartbeat communications (e.g., once every 60 seconds), so other components of system 800 can monitor the functionality of enforcement plane 822. In this example, the controller may communicate the heartbeat communications via messaging bus 824 and/or other means of communication.

In an embodiment, controllers within enforcement plane 822 are configured to aggregate and report information pursuant to controller settings that are defined for the controllers. The controller settings for a controller may dictate the content of reporting by the controller, the timing of reporting by the controller, the frequency of reporting by the controller, the format of reporting by the controller, the recipients of reporting by the controller, the means of communication for reporting by the controller, and/or other aspects of the controller's behavior. Additionally, or alternatively, the controller settings of a controller may include enforcement logic that is used by the controller to determine enforcement thresholds 810 for descendant devices of the controller's device.

In an embodiment, enforcement plane 822 includes one or more controller directors, and enforcement plane 822 includes one or more controller managers. As used herein, the term “controller director” refers to software and/or hardware configured to manage the operations of enforcement plane 822, and the term “controller manager” refers to software and/or hardware configured to manage a set of one or more controllers included in enforcement plane 822. A controller director is configured to direct the operations of controller manager(s). An example controller director monitors messaging bus 824 for updated topological information, budgeting information, workload characteristics, heartbeat communications, and/or other updated information that may be distributed to enforcement plane 822 from control plane 816 and/or other sources of information. Based on the updated information obtained by the example controller director, the example controller director may generate and transmit instructions to an example controller manager. Pursuant to instructions from the example controller director, the example controller manager may spawn new controller(s), redistribute existing controller(s), delete existing controller(s), and/or perform other operations. A controller director and/or a controller manager may be configured to update the controller settings of controllers within enforcement plane 822.

In an embodiment, messaging bus 824 refers to software and/or hardware configured to facilitate communications to and/or from components of system 800. Messaging bus 824 offers one or more APIs that can be used by components of system 800, components external to system 800, and/or users of system 800 to publish messages to messaging bus 824 and/or retrieve messages from messaging bus 824. By facilitating rapid communications between components of system 800, messaging bus 824 allow components of system 800 to quickly respond to changing circumstances (e.g., by implementing restrictions on resource utilization).

In an embodiment, messaging bus 824 is a cluster of interconnected computing nodes that facilitates the storage, distribution, and processing of one or more data streams. An example node of messaging bus 824 is a server that is configured to store and manage data (referred to herein as a “broker”). Information published to messaging bus 824 is organized into one or more categories of information that are referred to herein as “topics.” As used herein, the term “publisher” refers to an entity that publishes information to a topic of messaging bus 824, and the term “consumer” refers to an entity that reads information from a topic of messaging bus 824. Information published to a topic of messaging bus 824 may be collectively consumed by a set of one or more consumers referred to herein as a “consumer group.” Example topics that may be maintained by messaging bus 824 include a topology topic, a budgets topic, a BMC data topic, a BMC response topic, an aggregated data topic, an enforcement topic, a user instance metadata topic, a compute device metadata topic, an enforcement metadata topic, an enforcement alert topic, a heartbeat communications topic, a placement metadata topic, and other topics. A topic of the messaging bus 824 is typically organized into one or more subcategories of data that are referred to herein as “partitions.” The messages published to a topic are divided into the partition(s) of the topic. A message published to a topic may be assigned to a partition within the topic based on a key attached to the message. Messages that attach the same key are assigned to the same partition within a topic. A consumer of a consumer group may be configured to monitor a specific set of one or more partitions within a topic. Thus, a publisher of a message to a topic may direct the message to a specific consumer by attaching a key to that message that corresponds to a partition monitored by that specific consumer.

In an embodiment, messaging bus 824 includes one or more topology topics. A topology topic includes topological information and/or other information. Information is published to a topology topic by budget engine 814 and/or other publishers. Information published to a topology topic is consumed by enforcement plane 822 and/or other consumers. An example partition of a topology topic corresponds to an element in a topology 806 of a data center that represents a device in the data center. An example key attached to a message published to a topology topic is an element ID of an element in a topology 806 of a data center that represents a device in the data center. An example message published to a topology topic includes a timestamp, resource consumption metrics of the particular device (e.g., a 95% power draw value), the type of the particular device (e.g., BMC, rPDU, rack of hosts, busway, PDU, UPS, etc.), element IDs corresponding to child devices of the particular device, element IDs corresponding to parent devices of the particular device, and/or other information.

In an embodiment, messaging bus 824 includes one or more budgets topics. A budgets topic includes budgets 808 for devices and other information related to budgeting. Information is published to a budgets topic by control plane 816, urgent response loop 820, and/or other publishers. Information published to a budgets topic is consumed by enforcement plane 822 and/or other consumers. An example partition of a budgets topic corresponds to an element in a topology 806 of a data center that represents a device in the data center. An example key attached to a message published to a budgets topic is an element ID of an element in a topology 806 of a data center that represents a device in the data center. An example message published to a budgets topic includes a timestamp, a serial number of the device, and a budget 808 for the device.

In an embodiment, messaging bus 824 includes one or more BMC data topics. A BMC data topic of messaging bus 824 may include characteristics (e.g., resource consumption) of compute devices that are monitored by BMCs 826 and/or other information. Information is published to a BMC data topic by BMCs 826 and/or other publishers. Information published to the BMC data topic is consumed by enforcement plane 822 and/or other consumers. An example key attached to a message published to a BMC data topic is an identifier of a leaf-level device (e.g., a rack number). The content of a message published to a BMC data topic by a BMC 826 may vary depending on the reporting parameters assigned to that BMC 826. An example message published to a BMC data topic by a BMC 826 of a host may include a serial number of the host, a serial number of the BMC 826, an activation state of the host (e.g., enabled or disabled), a current enforcement threshold 810 imposed on the host, a time window for enforcing the current enforcement threshold 810, a minimum enforcement threshold 810, a maximum enforcement threshold 810, a pending enforcement threshold 810, a power state of the host (e.g., on or off), power consumption of the host, other sensor data of the host (e.g., CPU power draw, GPU power draw, fan speeds, inlet and outlet temperatures, etc.), a firmware version of the BMC, occupancy levels (e.g., utilization levels of computer resources), health data, fault data, and/or other information.

In an embodiment, messaging bus 824 includes one or more aggregated data topics. An aggregated data topic includes messages from child controllers of enforcement plane 822 that are directed to parent controllers of enforcement plane 822. Thus, information is published to an aggregated data topic by enforcement plane 822 and/or other publishers, and information published to an aggregated data topic is consumed by enforcement plane 822 and/or other consumers. A message published to an aggregated data topic includes information pertaining to the status of a device in a data center (e.g., aggregate resource consumption of descendant devices) and/or other information that is aggregated by a controller of that device. An example key attached to a message published to an aggregated data topic is an element ID of an element in a topology 806 of a data center that represents a parent device. In general, the content of messages published to an aggregated data topic may depend on the content of messages published to a BMC data topic. An example message published to an aggregated data topic by a controller of a device may include a timestamp, an ID of the device and/or a controller of the device, an ID of a parent device and/or parent controller, an aggregate power draw of the device, an enforcement threshold 810 currently imposed on the device, a minimum enforcement threshold 810, a maximum enforcement threshold 810, a pending enforcement threshold 810, occupancy levels, health data, fault data, and/or other information.

In an embodiment, messaging bus 824 includes one or more enforcement topics. An enforcement topic includes instructions for enforcing budgets 808 and/or other restrictions. Among other information, an enforcement topic may include enforcement thresholds 810 that are imposed on devices in a data center. Information is published to an enforcement topic by enforcement plane 822, urgent response loop 820, and/or other publishers. Information published to an enforcement topic may be consumed by enforcement plane 822, monitoring shim 828, compute control plane 818, user instance controllers, and/or other consumers. In general, the content of messages published to an enforcement topic may depend on the budget constraints included in a budget 808 that is being enforced, the intended enforcement mechanism for the budget 808, and other factors. An example message published to an enforcement topic may include a timestamp, element IDs, device serial numbers, enforcement thresholds 810, and/or other information.

In an embodiment, messaging bus 824 includes one or more user instance metadata topics. A user instance metadata topic includes metadata associated with user instances that are placed on compute devices (i.e., user instance metadata). Information is published to a user instance metadata topic by a compute control plane 818 and/or other publishers. Information published to a user instance metadata topic is consumed by control plane 816 and/or other consumers. An example message published to a user instance metadata topic includes a timestamp, an ID of a user instance, an ID of a host that the user instance is placed on, a user tenancy ID, a user priority level (e.g., low, medium, high, etc.), a cluster ID, a state of the user instance (e.g., running), and/or other information.

In an embodiment, messaging bus 824 includes one or more compute device metadata topics. A compute device metadata topic includes metadata associated with compute devices (i.e., compute device metadata). Information is published to a compute device metadata topic by a compute device metadata service 830, compute control plane 818, and/or other publishers. Information published to a compute device metadata topic is consumed by control plane 816 and/or other consumers. An example message published to a compute device metadata topic includes an ID of a host, an ID of a BMC 826 associated with the host (e.g., a serial number), an ID of a rack of hosts that includes the host, a lifecycle state of the host (e.g., pooled, in use, recycled, etc.), occupancy levels (e.g., virtualization density, schedule queue length, etc.), and/or other information.

In an embodiment, messaging bus 824 includes one or more enforcement metadata topics. An enforcement metadata topic of messaging bus 824 includes metadata that can be used as a basis for determining how to implement budgets 808 and/or enforcement thresholds 810 (referred to herein as “enforcement metadata”). Information is published to an enforcement metadata topic by control plane 816 and/or other publishers. Information published to the enforcement metadata topic is consumed by enforcement plane 822 and/or other consumers. An example key attached to a message published to an enforcement metadata topic is a serial number of a host. An example message published to an enforcement metadata topic includes a timestamp, a serial number of a host, a score assigned to a user instance placed on the host (e.g., 1-100) that indicates the importance of the user instance, a lifecycle state of the host, a user instance ID, a cluster ID, occupancy levels of the host (e.g., virtualization density, schedule queue length, etc.), and/or other information.

In an embodiment, a BMC 826 refers to software and/or hardware configured to monitor and/or manage a compute device. An example BMC 826 includes a specialized microprocessor that is embedded into the motherboard of a compute device (e.g., a host). A BMC 826 embedded into a compute device may be configured to operate independently of a main processor of the compute device, and the BMC 826 may be configured to continue operating normally even if the main processor of the compute device is powered off or functioning abnormally. A BMC is configured to communicate with other components of system 800, components external to system 800, and/or users of system 800 via messaging bus 824, API(s), and/or other means of communication. A BMC 826 may be configured to communicate with a user of system 800 via interface 832.

In an embodiment, a BMC 826 of a compute device is configured to report on the status of the compute device to enforcement plane 822 and/or other recipients. A BMC 826 of a compute device is configured to report on the status of the compute device pursuant to reporting parameters that have been defined for the BMC 826. The reporting parameters of a BMC 826 may stipulate the content of reporting by the BMC 826, the format of reporting by the BMC 826, the timing and frequency of reporting by the BMC 826, the recipients of reporting by the BMC 826, the method that reporting of the BMC 826 is to be communicated to recipients, and/or other aspects of reporting by the BMC 826. Note that the response time of the system 800 in responding to an occurrence may be a function of the reporting frequency of the BMCs 826 as defined by the BMCs' 826 reporting parameters. Similarly, the information that is available to the system 800 for detecting an occurrence and formulating a response to that occurrence may depend on the reporting parameters of the BMCs 826. The reporting parameters of a BMC 826 may be adjusted by enforcement plane 822, another component of system 800, or a user of system 800. The reporting parameters of a BMC 826 may be adjusted dynamically by a component of system 800 to better suit changing circumstances. In an example, a BMC 826 of a host is configured to report state information of the host to a leaf-level controller in enforcement plane 822 via messaging bus 824. In this example, the leaf-level device managed by the leaf-level controller is an ancestor device of the host (e.g., a rack of hosts that includes the host), and the BMC 826 is configured to publish state information of the host to a partition of a BMC data topic corresponding to the leaf-level device.

In an embodiment, a BMC 826 of a compute device is configured to serve as a mechanism for enacting budgets 808 and enforcement thresholds 810 by limiting resource utilization of the compute device. In particular, a BMC 826 of a compute device may be configured to enact enforcement thresholds 810 imposed on that compute device. A BMC 826 may be configured to enforce an enforcement threshold 810 that includes power restrictions, thermal restrictions, network restrictions, use restrictions, and/or other types of restrictions. In an example, a BMC 826 of a host may be configured to enforce a power cap threshold imposed on the host by a leaf-level controller (e.g., a rack controller) by enacting a hard limit on the power consumption of the host that is defined by the power cap threshold. By enforcing an enforcement threshold 810 imposed on a compute device, a BMC 826 of the compute device contributes to the enforcement of budgets 808 and/or enforcement thresholds 810 assigned to ancestor devices of the compute device. A BMC 826 of a compute device may be configured to restrict the resource consumption of a particular component of the compute device. For example, a BMC 826 of a host may be configured to impose an individual cap on the power that is consumed by a GPU of the host, and/or the BMC of the host may be configured to impose an individual cap on the power that is consumed by a CPU of the host.

In an embodiment, monitoring shim 828 refers to software and/or hardware configured to (a) detect restrictions on resource utilization and (b) trigger the alerting of entities that may be impacted by the restrictions on resource utilization. Monitoring shim 828 is configured to communicate with other components of system 800, components external to system 800, and/or users of system 800 via messaging bus 824, API(s), and/or other means of communication. Monitoring shim 828 may be configured to communicate with a user of system 800 via interface 832.

In an embodiment, monitoring shim 828 is configured to (a) detect the imposition of restrictions on resource utilization imposed on devices of a data center and (b) trigger the sending of alerts to users of the data center that may be impacted by the restrictions. In an example, monitoring shim 828 is configured to monitor an enforcement topic of messaging bus 824 for the imposition of enforcement thresholds 810 on devices of a data center. If monitoring shim 828 identifies an enforcement threshold 810 that is being imposed on a device in this example, monitoring shim 828 is further configured to direct compute control plane 818 to alert data center users that may be impacted by the enforcement threshold 810. For instance, if an enforcement threshold 810 is imposed on a host of the data center in this example, monitoring shim 828 may instruct compute control plane 818 to alert an owner of a user instance that is placed on the host.

In an embodiment, device metadata service 830 refers to software and/or hardware configured to provide access to information associated with compute devices and/or compute workloads (i.e., compute metadata). Device metadata service 830 may expose one or more APIs that can be used to obtain compute metadata. Device metadata service 830 is configured to communicate with other components of system 800, components external to system 800, and/or users of system 800 via messaging bus 824, API(s), and/or other means of communication. Device metadata service 830 may be configured to communicate with a user of system 800 via interface 832.

In an embodiment, device metadata service 830 is configured to provide access to compute metadata that can be used as a basis for budgeting determinations. In particular, device metadata service 830 is configured to provide other components of system 800 (e.g., control plane 816, compute control plane 818, budget engine 814, etc.) access to compute device metadata. As an example, consider a host in a data center. In this example, device metadata service 830 is configured to provide access to compute device metadata of the host, such as an ID of the host, a serial number of a BMC 826 associated with the host, a rack number of a rack of hosts that includes the host, a lifecycle state of the host, and/or other information. Example lifecycle states of a host include pooled, in use, recycled, and others.

In an embodiment, interface 832 refers to software and/or hardware configured to facilitate communications between a user and components of system. Interface 832 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 832 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 832 is specified in one or more other languages, such as Java, C, or C++.

In an embodiment, system 800 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, a tenant is a corporation, organization, enterprise or other entity that accesses a shared computing resource.

### 6. Budget Enforcement

FIG. 9 illustrates an example set of operations for enforcing budgeting in accordance with one or more embodiments. One or more operations illustrated in FIG. 9 may be modified, rearranged, or omitted all together. Accordingly, the particular sequence of operations illustrated in FIG. 9 should not be construed as limiting the scope of one or more embodiments.

In an embodiment, a controller of a device obtains message(s) that pertain to the statuses of descendant device(s) of the device (Operation 902). Hereafter, the one or more messages obtained by the controller of the device are referred to as “the messages,” and the one or more descendant devices whose statuses are described by the messages are referred to as the “target devices.” The messages include state information of the target devices and/or other information. Example state information of the target devices that may be reported in the messages includes measurements and/or estimates of the resources that are being utilized by the target devices, the enforcement settings of the target devices, theoretical enforcement settings that could be imposed on the target devices, the occupancy of the target devices, the health of the target devices, and other information pertaining to the statuses of the target devices. The target devices may be child devices of the controller's device, and/or the target device may be further descendant devices of the controller's device. The target devices may be a subset of the descendant devices of the controller's device, or the target devices may be the totality of the descendant devices of the controller's device. The target devices may be the same type of device (e.g., compute devices, power infrastructure devices, etc.), and/or the target devices may include different types of devices. The controller of the device is one of multiple controllers spawned in an enforcement plane of the system to manage a network of devices that includes the device. The origin of the messages and the identity of the target devices may depend on if the controller of the device is (a) a parent controller that possesses one or more child controllers in the enforcement plane or (b) a leaf-level controller.

In an embodiment, the controller of the device is a parent controller that possesses one or more child controllers in the enforcement plane (referred to hereafter as “the child controllers”). In this embodiment, the messages obtained by the controller of the device originate from the child controllers, and the target devices (i.e., the devices described by the messages) are the descendant devices that are managed by the child controllers. The child controllers manage child devices of the controller's device, and/or the child controllers manage further descendants devices of the controller's device. In a first example, the controller is a UPS controller, and the child controllers are PDU controllers. In a second example, the controller is a PDU controller, and the child controllers are busway controllers. In a third example, the controller is a busway controller, and the child controllers are rack controllers. In a fourth example, the controller is a rack controller, and the child controllers are rPDU controllers.

In an embodiment, the controller of the device is a leaf-level controller. As noted above, a “leaf-level controller” is a controller that possesses no child controllers in the enforcement plane, and a “leaf-level device” is a device managed by a leaf-level controller. In this embodiment, the messages originate from BMCs of compute devices that are descendant devices of the controller's device, and the messages describe the statuses of the compute devices. In other words, the compute devices that are descendant devices of the controller's device are the target devices. In general, the devices in a network of devices that are managed by leaf-level controllers may vary depending on the level of granularity that is appropriate for budgeting resource utilization. In a first example, the controller's device is a UPS, and the messages originate from BMCs of hosts that are descendant devices of the UPS. In a second example, the controller's device is a PDU, and the messages originate from BMCs of hosts that are descendant devices of the PDU. In a third example, the controller's device is a busway, and the messages originate from BMCs of hosts that are descendant devices of the busway. In a fourth example, the controller's device is a rack of hosts, and the messages originate from BMCs of the hosts included in the rack of hosts.

In an embodiment, the messages are communicated to the controller of the device through a messaging bus of the system. The messages are published to a topic of the messaging bus that is used to communicate information pertaining to the statuses of descendant devices (e.g., an aggregated data topic or a BMC data topic). In particular, the messages are published to a partition of this topic that corresponds to the controller and the device. Once published to this partition, a consumer of the partition may read the messages from the partition. The consumer of this partition may be the controller of the device, or the consumer of this partition may be another component of the system that is configured to pass the messages to the controller. As an example, assume that the controller of the device is a parent controller. In this example, the controller's child controllers publish the messages to an aggregated data topic of the messaging bus, and the child controllers each attach the same key to the messages. The key attached to the messages in this example corresponds to the controller and the device. For instance, the key attached to the messages in this example may be an identifier of the controller or an identifier of the device. As a result, the messages published by the child controllers to the aggregated data topic in this example are organized into a partition of the aggregated data topic that corresponds to the controller and the device. A consumer of this partition in this example reads the messages published by the child controllers, and the consumer writes these messages to a cache where the messages can be retrieved by the controller. In this example, the controller of the device obtains the messages by retrieving the messages from the cache. As another example, assume that the controller is a leaf-level controller. In this other example, the messages are communicated to the controller of the device through a BMC data topic, and the messages are published to the BMC data topic by BMCs of hosts that are descendant devices of the device. The BMCs of the hosts attach the same key to the messages in this other example. In this other example, the key attached to the messages corresponds to the controller and the device. For instance, if the controller's device is a rack of hosts in this other example, the key attached to the messages by the BMCs may identify a rack number of the rack of hosts. As a result, the messages published by the BMCs to the BMC data topic in this other example are organized into the partition of the BMC data topic that corresponds to the controller and the device. A consumer of this partition reads the messages published by the BMCs in this other example, and the consumer writes the messages to a cache where the messages can be retrieved by the controller. In this other example, the controller of the device obtains the messages by retrieving the messages from the cache.

In an embodiment, the controller of the device aggregates information from the messages (Operation 904). By aggregating information from the messages, the controller of the device may ascertain the status of the device. For instance, the controller of the device may ascertain the resources that are being utilized by the device and/or the descendant devices, the current enforcement settings of the device, theoretical enforcement settings for the device, occupancy levels of the device, health data of the device, and other information pertaining to the status of the device. With respect to the resources that are being utilized by the controller's device and/or the descendant devices, the controller may determine the power that is being drawn by the device, the aggregate heat that is being output by the device and/or the descendant devices, the aggregate cooling capacity that is being consumed by the device and/or the descendant devices, the network resources (e.g., bandwidth) that are being utilized by the device and/or the descendant devices, and other information.

In an embodiment, the controller of the device determines the power that is being drawn by the device from a parent device of the device. The controller of the device may determine the power draw of the device from the parent device based on measurements and/or estimates of power draw that are included in the messages. As an example, assume that the controller of the device is a parent controller. For the purposes of this example, further assume that the controller's device is a busway, and the controller's child controllers manage racks of hosts that are distributed electricity through the busway. In this example, the messages from the child controller (i.e., the rack controllers) to the controller of the device (i.e., the busway) report on the power that is being drawn from the busway by the individual racks of hosts, and the controller may approximate the aggregate power that is being drawn by the busway from a parent device of the busway (e.g., a PDU) by adding together the power draw values reported by the rack controllers in the messages. As another example, assume that the controller of the device is a leaf-level controller, and the controller's device is a rack of hosts. In this example, messages from the BMCs of the hosts in the rack of hosts to the controller of the device (i.e., the rack of hosts) report on the power that is being consumed by the individual hosts, and the controller may approximate the aggregate power that is being drawn by the rack of hosts from a parent device of the rack of hosts (e.g., a busway) by adding together the individual power consumption values that are reported by the BMCs of the hosts. Additionally, or alternatively, the controller of the device determines the power that is being drawn by the device by other means. For example, the controller of the device may determine the power draw of the device based on a measurement by a power meter that is upstream of the controller's device.

In an embodiment, if the controller of the device has a parent controller in the enforcement plane, the controller reports on the status of the device to the parent controller (Operation 906). For instance, the controller of the device may report to the parent controller regarding the resources that are being drawn by the device and/or the descendant devices, the current enforcement setting of the device, theoretical enforcement settings for the device, occupancy levels of the device, health data of the device, and other information pertaining to the status of the device. Alternatively, if the controller of the device does not have a parent controller (i.e., the controller is not a child controller), the controller may this operation. If the controller of the device has a parent controller, the parent controller may manage a parent device of the device, or the parent controller may manage a more distant ancestor device of the device. For example, if the controller's device is a busway, the parent controller may be configured to manage an ancestor device that distributes electricity to the busway (e.g., a PDU), and the controller may be configured to report on the status of the busway to the parent controller of the ancestor device. Additionally, or alternatively, a parent controller may manage an aggregation of devices. In other words, a parent controller does not necessarily manage one specific ancestor device of the controller's device. For example, a parent controller of the controller may be configured to manage a room of a facility that includes the controller's device and other devices that are managed by other controllers. If the controller of the device has a parent controller, the controller has a single parent controller, or the controller has multiple parent controllers. If the controller has multiple parent controllers, the controller may report to one or more of the parent controllers. Additionally, or alternatively, the controller may be configured to report to a controller that is not a parent controller. For example, the controller may be configured to report to a controller that manages a device that supports the operation of the controller's device (e.g., an atmospheric regulation device that regulates an environment that includes the controller's device).

In an embodiment, the controller of the device has a parent controller, and the controller reports the power that is being drawn by the device to the parent controller. As an example, assume that the device is a busway, and further assume that a PDU is distributing electricity to the busway. In this example, the controller reports the power draw of the busway to a controller of the PDU (i.e., the controller's parent controller). An example message reporting the power draw of the controller's device to a parent controller may include a timestamp, an ID of the parent device and/or an ID of the parent controller, an ID of the controller's device and/or an ID of the controller, a current power draw of the controller's device, a maximum enforcement threshold that could be imposed on the controller's device, a minimum enforcement threshold that could be imposed on the controller's device, and/or other information.

In an embodiment, the controller of the device has more than one parent controller. For example, the controller of the device may have a parent controller that manages a normal parent device of the device that is configured to supply electricity to the device during normal operating conditions, and the controller may have a backup parent controller that manages a backup parent device that is configured to supply electricity to the device in abnormal operating conditions (e.g., in the event of the normal parent device failing). In this example, the controller of the device may be configured to report to one or both of the normal parent controller and/or the backup parent controller depending on the circumstances.

In an embodiment, the controller of the device has a parent controller, and the controller reports to the parent controller through the messaging bus. As an example, assume that the controller's device is a busway that distributes electricity to multiple racks of hosts. In this example, the parent controller manages a PDU that distributes electricity to the busway and other busways (i.e., sibling devices of the controller's device). The controller of the device reports to the parent controller of this example by publishing a message to an aggregated data topic of the messaging bus. In this example, the controller of the device attaches a key to this message that includes an element ID of an element in a topology of the network of devices that represents the PDU. As a result, the message published by the controller's device is organized into a partition of the aggregated data topic that corresponds to the parent controller and the PDU.

In an embodiment, the controller of the device is configured to report on the status of the device pursuant to a set of controller settings that are defined for the controller. The controller settings for the controller of the device may dictate the content of reporting by the controller, the timing of reporting by the controller, the frequency of reporting by the controller, the format of reporting by the controller, the recipients of reporting by the controller, the method of communication for reporting by the controller, and/or other aspects of the controller's reporting. The controller setting for the controller of the device may be adjusted dynamically by other components of the system (e.g., a controller manager, a controller director, a user of the system, etc.) to better suit changing circumstances. Additionally, or alternatively, the controller settings for a device may include enforcement logic that is used by the controller to determine descendant devices of the controller's device.

In an embodiment, the controller of the device determines if the current enforcement settings for the target devices should be updated, and the controller proceeds to another operation based on the determination (Operation 908). In other words, the controller of the device determines if new enforcement thresholds should be imposed on any of the target devices, and/or the controller determines if there are any enforcement thresholds currently imposed on the target device that should be lifted. If the controller of the device determines that the current enforcement settings for the target devices should be updated (YES at Operation 908), the controller proceeds to Operation 910. Alternatively, if the controller of the device decides against updating the current enforcement settings for the target devices at this time (NO at Operation 908), the controller returns to Operation 902. The controller of the device may determine if the current enforcement settings for the target devices should be updated based on the information that the controller has aggregated from the messages, any restrictions that are applicable to the controller's device, and/or other information. For example, the controller of the device may have determined the approximate power that is being drawn by the device from a parent device based on power draw values reported in the messages, and the controller may compare that approximate power draw value to any power-based budget constraints and/or enforcement thresholds that are currently applicable to the device to determine if the current enforcement settings of the target devices should be updated. Additionally, or alternatively, the controller may determine that the current enforcement settings for the target devices should be updated based on receiving a command to implement urgent restrictions on resource utilization from an urgent response loop, another component of the system, or a user of the system.

In an embodiment, the controller of the device concludes that current enforcement settings for the target devices should be updated to include more stringent restrictions because the device is exceeding or is at risk of exceeding one or more budget constraints of a budget assigned to the device. The controller of the device may obtain a budget assigned to the device from a budgets topic of the messaging bus and/or other sources of information. A budget assigned to the controller's device may include power restrictions, thermal restrictions, network restrictions, use restrictions, and/or other types of restrictions. In an example, a budget constraint of a budget assigned to the controller's device restricts the power that may be drawn by the device from a parent device. In this example, the controller of the device compares the power draw of the device to the budget constraint. If the power draw of the controller's device is exceeding or is at risk of exceeding the budget constraint, the controller may conclude that new power cap threshold(s) should be imposed on the target devices in this example.

In an embodiment, the controller of the device concludes that current enforcement settings for the target devices should be updated to include more stringent restrictions because the device is exceeding or is at risk of exceeding one or more enforcement thresholds imposed on the device. The controller of the device may obtain an enforcement threshold that is imposed on the device from an enforcement topic of the messaging bus and/or other sources of information. An enforcement threshold may be imposed on the controller's device by a parent controller of the controller. An enforcement threshold imposed on the controller's device may include power restrictions, thermal restrictions, network restrictions, use restrictions, and/or other types of restrictions. In an example, a power cap threshold imposed on the controller's device restricts the power that may be drawn by the device from a parent device. In this example, the controller of the device compares the power draw of the device to the power cap threshold. If the power draw of the controller's device is exceeding or is at risk of exceeding the power cap threshold, the controller may conclude that new power cap threshold(s) should be imposed on the target devices in this example.

In an embodiment, the controller of the device concludes that the current enforcement settings for the target devices should be updated to include less stringent restrictions because the device is no longer exceeding or is no longer at a significant risk of exceeding one or more budget constraints and/or enforcement thresholds that are applicable to the device.

In an embodiment, the controller of the device determines updated enforcement settings for the target devices (Operation 910). The updated enforcement settings for the target devices may be more or less restrictive than the current enforcement settings for the target devices. The updated enforcements settings may be more restrictive than the current enforcement settings in some respects, and the updated enforcement settings may be less restrictive than the current enforcement settings in other respects. While generating the updated enforcement settings, the controller of the device may determine new enforcement threshold(s) for the descendant devices, and/or the controller of the device may decide that enforcement threshold(s) currently imposed on the descendant devices should be lifted. In an example, the risk of the controller's device exceeding a restriction applicable to the device (e.g., a budget constraint or an enforcement threshold) has increased since the enforcement settings for the descendant devices were last updated, and the controller determines new enforcement threshold(s) that are formulated to further restrict the resource utilization of the target devices. In this example, the controller of the device may determine a new enforcement threshold for a target device that is more stringent than an enforcement threshold that is currently imposed on that target device, and/or the controller may determine a new enforcement threshold for a target device that is not currently being subjected to an enforcement threshold. In an alternative example, the risk of the controller's device exceeding a restriction applicable to the device has reduced since the enforcement settings for the child devices were last updated. In this alternative example, the controller of the device determines new enforcement threshold(s) that are less stringent than current enforcement threshold(s) imposed on the target devices, and/or the controller decides to lift enforcement threshold(s) that are currently imposed on the target devices.

In an embodiment, the controller of the device determines new enforcement threshold(s) for target device(s). The controller may determine a single enforcement threshold for a target device, or the controller determines multiple enforcement thresholds for the target device. The controller determines enforcement threshold(s) for a single target device, or the controller determines enforcement thresholds for multiple target devices. If the controller determines multiple enforcement thresholds for multiple target devices, the multiple enforcement thresholds allocate a resource (e.g., electricity) equally amongst the multiple target devices, or the multiple enforcement thresholds allocate resources unequally amongst the target devices. The enforcement threshold(s) may be formulated by the controller of the device to bring about the device's compliance with one or more restrictions that are applicable to the device (e.g., budget constraints assigned to the device and/or enforcement thresholds imposed on the device). Additionally, or alternatively, the enforcement thresholds determined by the controller of the device may be determined based on some stimuli other than a violation or a potential violation of a restriction that applies specifically to the device. For instance, the enforcement thresholds may be determined by the controller of the device based on a command that originates from an urgent response loop. Example inputs that may be a basis for determining an enforcement threshold for a target device include information pertaining to the status of the device, information pertaining to the status of the target device, information pertaining to the status of other target devices, enforcement metadata, operating conditions, topologies, and other information.

In an embodiment, the controller of the device eases or lifts one or more enforcement thresholds that are currently imposed on the target devices. The controller of the device may ease a current enforcement threshold imposed on a target device by determining a new enforcement threshold for the target device that is less stringent than the current enforcement threshold.

In an embodiment, the controller of the device determines new enforcement settings for the target devices based on relative priority levels of workloads that are supported by the target devices. The controller may determine the relative priority levels of the workloads that are supported by the target devices based on enforcement metadata. The controller may obtain the enforcement metadata from an enforcement metadata topic of the messaging bus. The enforcement metadata is published to the enforcement metadata topic by a control plane of the system. The control plane generates the enforcement metadata based on compute metadata and/or other information that originates from a compute control plane of the system, a device metadata service of the system, and/or other sources of information. In an example, the controller of the device obtains enforcement metadata that relates to the user instances that are placed on the hosts that are descendant devices of the controller's device (i.e., child devices or further descendant devices). In this example, the hosts are the target devices, or the hosts are descendant devices of the target devices. The enforcement metadata obtained by the controller of the device in this example may include scores (e.g., 1-100) for user instances that are placed on these hosts. The scores were calculated by the control plane based on compute metadata (e.g., user instance metadata) associated with the user instances. A score that is assigned to a user instance in this example indicates that user instance's level of importance relative to the other user instances. Based on the scores assigned to the user instances in this example, the controller determines new enforcement settings for target devices in a manner that mitigates the impact to higher-priority user instances. For instance, if the user instance(s) supported by one target device have lower score(s) than the user instance(s) supported by another target device in this example, the controller of the device may determine new enforcement threshold(s) such that the one target device is restricted instead of, prior to, and/or more stringently than the other target device. Additionally, or alternatively, the controller of device may ease or lift any enforcement threshold that is imposed on the other target device prior to, instead of, and/or to a greater degree than any enforcement threshold that is imposed on the one target device in this example.

In an embodiment, the controller of the device determines new enforcement settings for the target devices based on relative occupancy levels associated with the target devices. The controller may consider the occupancy levels of compute devices that are descendant devices of the controller's device, and/or the controller may consider the occupancy levels of any power infrastructure devices that are descendant devices of the controller's device. Example metrics that may be used to measure the occupancy level of a compute device include CPU utilization (e.g., %), memory utilization, disk I/O utilization, network bandwidth utilization, load averages, virtualization density, heat output, power consumption, schedule queue length, and other metrics. Example metrics that may be used to gauge the occupancy of a power infrastructure device include current, voltage, watts, trip threshold ratings, current ratings, and other metrics. Additionally, or alternatively, the controller may consider the occupancy levels of other types of devices (e.g., atmospheric regulation devices) that support the operation of the descendant devices of the controller's device. Depending on the controller's device and the manner that occupancy is measured, the controller may obtain occupancy levels of the ancestor compute devices from an aggregated data topic of messaging bus, a BMC data topic of messaging bus, an enforcement metadata topic of messaging bus, and/or another source of information. As an example, assume that the controller's device is a rack of hosts. In this example, the controller of the device may determine enforcement thresholds for the hosts in the rack of hosts such that a lower-occupancy host is restricted instead of, prior to, and/or more stringently than a higher-occupancy host. Additionally, or alternatively, the controller of the device (i.e., the rack of hosts) may ease or lift any enforcement threshold that is imposed on the higher-occupancy host prior to, instead of, and/or to a greater degree than any enforcement threshold that is imposed on the lower-occupancy host in this example. As another example, assume that the controller's device is a busway that distributes electricity to multiple racks of hosts. In this other example, the controller of the device (i.e., the busway) may determine enforcement thresholds for the racks of hosts such that a lower-occupancy rack of hosts is restricted instead of, prior to, and/or more stringently than a higher-occupancy rack of hosts. Additionally, or alternatively, the controller of the device may ease or lift an enforcement threshold that is imposed on the higher-occupancy rack of hosts prior to, instead of, and/or to a greater degree than an enforcement threshold that is imposed on the lower-occupancy rack of hosts in this other example.

In an embodiment, the controller of the device determines new enforcement settings for the target devices based on the relative health of the target devices and/or the relative health of any descendant devices of the target devices. For example, if the target devices are power infrastructure devices, the controller of the device may consider the health of the power infrastructure devices, and the controller of the device may consider the health of the respective compute devices that are distributed electricity from the power infrastructure devices. Additionally, or alternatively, the controller may consider the health of other types of devices (e.g., atmospheric regulation devices) that support the operation of the target devices and/or any descendant devices of the target device. For example, the controller of the device may consider the health of different atmospheric regulation devices that support the target devices and/or any descendant devices of the target device. The controller of the device may obtain health data from an aggregated data topic, a BMC data topic, an enforcement metadata topic, other topics of the messaging bus, and/or other sources of information. In an example, the controller's device is a rack of hosts, and the hosts included in the rack of hosts are target devices. In this example, the controller of the device may determine enforcement thresholds for the hosts in the rack of hosts such that an unhealthy host is restricted instead of, prior to, and/or more stringently than a healthy host. Additionally, or alternatively, the controller of the device may ease or lift an enforcement threshold that is imposed on the healthy host prior to, instead of, and/or to a greater degree than an enforcement threshold that is imposed on the unhealthy host in this example. In this example, the controller of the device may gauge the health of a host in terms of the capacity of the host's computer resources, performance metrics of the host, the capacity of the host's cooling systems, the temperature of the host, and/or other aspects of the host.

In an embodiment, the controller of the device is part of a hierarchy of controllers in the system's enforcement plane, and the controller's position within a hierarchy of controllers may influence how the controller determines new enforcement settings for the target devices. For instance, in one example configuration of the enforcement plane, parent controllers are configured to determine equal enforcement thresholds for the devices managed by child controllers, and leaf-level controllers are configured to determine enforcement thresholds for compute devices that are tailored to the circumstances of those compute devices. Thus, if the controller of the device is a parent controller in this example, the controller will determine equal enforcement thresholds for the target devices. On the other hand, if the controller of the device is a leaf-level controller in this example, the controller may determine equal enforcement thresholds for the target device or unequal enforcement thresholds for the target devices depending on the circumstances. However, in another example configuration of the enforcement plane, controllers throughout a hierarchy of controllers are configured to determine enforcement thresholds for ancestor devices that are tailored to the circumstances. Thus, in this other example, the controller of the device may determine equal enforcement thresholds for the target devices or unequal enforcement thresholds for the target devices regardless of where the controller is situated within the hierarchy of controllers.

In an embodiment, the controller of the device determines enforcement threshold(s) for the target devices pursuant to a one-deep-cut policy. Pursuant to the one-deep-cut policy, the controller of the device instructs child controllers of the target devices or BMCs of the target devices to implement the maximum enforcement thresholds of the target devices. Implementing a one deep-cut policy may allow the system to quickly reduce resource consumption in emergency situations. In an example, the controller of the device implements a one-deep-cut policy at the direction of an urgent response loop, and the controller implements the one-deep-cut policy by instructing child controllers or BMCs to enact the maximum power cap thresholds for the target devices. An example maximum power cap threshold for a target device is configured to restrict the power draw of the target device to a lowest value that can be sustained while the target device remains operational for its intended purpose. Pursuant to an example one-deep-cut policy, maximum enforcement thresholds may be imposed on devices throughout a network of devices in response to an issue that impacts the entirety of the network of devices, or maximum enforcement thresholds may be imposed on a subset of the devices in the network of devices in response to a localized issue that impacts the subset of the devices in the network of devices. In an example of the former scenario, maximum power cap thresholds are imposed on devices throughout the network of devices in response to a sudden drop in the supply of electricity to the network of devices (e.g., through a utility power connection). In an example of the latter scenario, maximum power cap thresholds are imposed on a subset of devices in the network of devices in response to indications that a device supporting that subset of devices has failed or is failing. A one-deep-cut policy may be implemented while the system monitors an emergency condition and determines what next steps are appropriate for responding to the emergency condition.

In an embodiment, the controller of the device imposes the updated enforcement settings on the target devices (Operation 912). The controller of the device imposes the updated enforcement settings on the target devices by communicating the updated enforcement settings to one or more enforcement mechanisms. The controller of the device may communicate the updated enforcement setting to an enforcement mechanism through enforcement topic(s) of the messaging bus, API(s), and/or other means of communication. The controller of the device relies on a single enforcement mechanism to enforce the updated enforcement settings, or the controller relies on multiple enforcement mechanisms to enforce the updated enforcement settings. Example enforcement mechanisms that may be leveraged by the controller of the device to enforce the updated enforcement settings include BMCs of compute devices, a compute control plane, user instance controllers, enforcement agents, and other enforcement mechanisms.

In an embodiment, the controller of the device relies on BMCs of compute devices to enforce the updated enforcement settings. In this embodiment, the compute devices are the target devices, or the compute devices are descendant devices of the target devices. If the controller of the device is a leaf-level controller, the controller communicates the updated enforcement settings to the BMCs of the compute devices (i.e., the target devices). If the controller of the device is a parent controller, the controller communicates the updated enforcement thresholds to the child controllers, and the child controllers will then repeat the operations illustrated in FIG. 6 to determine new enforcement settings for descendant devices of the target devices. New enforcement settings may be determined by controllers at each level in the hierarchy of controllers that is below the controller of the device. In either scenario, the target devices will be brought into compliance with the updated enforcement settings as a result of BMCs of compute devices limiting the activity of the compute devices. Various techniques are contemplated for a BMC limiting the activity of a compute device. The technique employed by a BMC to limit the activity of a compute device pursuant to an enforcement threshold imposed on the compute device may depend on the types of constraint(s) defined by the enforcement threshold. In an example, the target devices are brought into compliance with the updated enforcement settings as a result of BMCs of hosts preventing the BMCs' respective hosts from consuming power above threshold levels defined in power cap thresholds that are imposed on the hosts pursuant to the updated enforcement settings. In this example, a power cap threshold imposed on a host may include individual restrictions on a GPU of the host, a CPU of the host, and/or other components of the host. Additionally, or alternatively, the target devices may be brought into compliance with the updated enforcement settings as a result of BMC(s) shutting down host(s) in this example (e.g., unoccupied hosts, unhealthy hosts, etc.).

In an embodiment, the controller of the device relies on a compute control plane to enforce the updated enforcement settings by opening or closing devices to placement. To enforce the updated enforcement settings, the compute control plane may close compute devices, and/or the compute control plane may close ancestor devices of compute devices. Closing a compute device prevents additional workloads from being assigned to that compute device. For example, closing a host prevents additional user instances from being placed on that host while the host remains closed. Closing an ancestor device to placement (e.g., a power infrastructure device) prevents user instances from being placed on compute devices that are descendant devices of the ancestor device. For example, closing a rack of hosts prevents additional user instances from being placed on any of the hosts that are included in the rack while the rack of hosts remains closed. The more descendant devices that a device possesses, the more impactful that closing that device will be on resource utilization. Thus, closing devices near the top of a network of devices in may serve as a means for implementing course-grain restrictions on resource utilization, and closing devices near the bottom of the network of devices may serve as a means of implementing fine-grain restrictions on resource utilization. By closing a subset of the devices in a network of devices, the system may respond to localized surges in resource consumption within the network of devices while allowing unaffected devices within the network to remain open for assignment of additional workloads. Enforcement commands from the enforcement plane to the compute control plane may be facilitated by the messaging bus, API(s), and/or other means of communication.

In an embodiment, the controller of the device relies on a user instance controller to enforce the updated enforcement settings. The user instance controller operates at a hypervisor level of compute device(s) that are descendant devices to the controller's device. As an example, assume that the controller's device is a rack of hosts and the target devices are hosts included in the rack of hosts. In this example, the controller of the device may instruct a virtual machine controller operating at a hypervisor level of a host to enforce an enforcement threshold imposed on the host by limiting the activity of a virtual machine that is currently placed on the host. A user instance controller may offer various methods that provide for fine-grain control over the resource consumption of compute devices. For instance, a user instance controller may be instructed to enforce the updated enforcement settings in a manner that mitigates the impact of the updated enforcement settings to a subset of users. In an example, the user instances placed on a host are owned by users of differing levels of priority, and a user instance controller implements a power cap threshold imposed on the host in a manner that limits the disruption to the user instances that are owned by higher-priority users.

In an embodiment, the controller of the device relies on an enforcement agent to enforce the updated enforcement settings. An example enforcement agent executes on the computer system of a user, and the example enforcement agent is configured to facilitate the enforcement of the updated enforcement settings by restricting the activities of the user. In an example, the controller's device is a rack of hosts, and the target devices are hosts included in the rack of hosts. In this example, the controller of the device generated new enforcement thresholds for hosts in the rack of hosts that support user instances owned by lower-priority users, and the controller instructs enforcement agent(s) to enforce the new enforcement thresholds by limiting the activities of the lower-priority users.

### 7. Workload Assignment

FIG. 10 illustrates an example set of operations for selective placement of workloads in accordance with one or more embodiments. One or more operations illustrated in FIG. 10 may be modified, rearranged, or omitted. Accordingly, the particular sequence of operations illustrated in FIG. 10 should not be construed as limiting the scope of one or more embodiments.

In an embodiment, the system receives a request for assignment of a workload to a compute device included in a network of devices (Operation 1002). In addition to compute devices, the network of devices includes ancestor devices that support the operation of the compute devices (e.g., power infrastructure devices). In an example, the network of devices corresponds to an electricity distribution network, and the request is for placement of a user instance (e.g., a virtual machine, a container, etc.) on a host (e.g., a CPU server, a GPU chassis, etc.) included in the network of devices. In this example, the request originates from a user, and the request is received by a compute control plane of the system. It may be, in this example, that dynamic power capping is ongoing in the network of devices at the time the request is received by the compute control plane. For instance, at the time the request is received in this example, enforcement thresholds may be imposed on devices in the network of devices, and some hosts in the network of devices may be closed to placement of new user instances.

In an embodiment, the system identifies a candidate device for assignment of the workload (Operation 1004). To identify the candidate device, the system may consider the enforcement settings of the devices in the network of devices. For instance, the enforcement settings of a device in the network of devices may indicate if that device is open or closed. If a compute device is closed, then placing workloads on the compute device is prohibited so long as the compute device remains closed. If an ancestor device is closed, then placing workloads on compute devices that are descendant devices of the ancestor device is prohibited so long as the ancestor device remains closed. Therefore, a compute device may be selected as a candidate device for assignment of the workload if (a) the compute device is marked as open and (b) the ancestor devices of the compute device are marked as open. In addition, the system may consider various other criteria as a basis for selecting the candidate device. For instance, the system may consider the type of the workload, the types of compute devices that are suitable for that workload, characteristics of the user associated with the request, and/or other information.

In an embodiment, the system determines if assignment of the workload to the candidate device is appropriate, and the system proceeds to another operation based on the determination (Operation 1006). To determine if the assignment of the workload to the candidate device is appropriate, the system evaluates whether or not assignment of the workload to the candidate device poses a risk of exceeding a restriction that is associated with candidate device. General examples of restrictions that may be associated with the candidate device include budget constraints, enforcement thresholds, hardware and/or software limitations, and other restrictions. The restrictions that are associated with the candidate device may include power restrictions, thermal restrictions, network restrictions, use restrictions, and other types of restrictions. The system may determine whether or not assignment of the workload to the candidate device poses a significant risk of exceeding a restriction associated with the candidate device based on characteristics of the workload, characteristics of a user associated with the workload, the current state of the candidate device (e.g., power draw, occupancy, health, temperature, etc.), the current state of ancestor devices of the candidate device, the current state of other devices that support the operation of the device (e.g., atmospheric regulation devices, network infrastructure devices, etc.), and/or other information. In general, the system may conclude that assignment of the workload to the candidate device is appropriate if this assignment does not pose a significant risk of exceeding a restriction associated with the candidate device. If assignment of the workload to the candidate device is appropriate (YES at Operation 1006), the system proceeds to Operation 1008. Alternatively, if assignment of the workload to the candidate device is not appropriate (NO at Operation 1006), the system returns to Operation 1004.

In an embodiment, the system determines if assignment of the workload to the candidate device poses a significant risk of exceeding a restriction that specifically applies to the candidate device. For instance, the system may determine if assignment of the workload to the candidate device poses a significant risk of exceeding a budget constraint assigned to the candidate device, an enforcement threshold imposed on the candidate device, hardware and/or software limitations of the candidate device, and/or other restrictions that are specific to the candidate device. In an example, the workload is a user instance, and the candidate device is a host that is included in a rack of hosts. In this example, the system determines if placing the user instance on the host poses a significant risk of exceeding any budget constraints assigned to the host, enforcement thresholds imposed on the host, hardware and/or software limitations of the host (e.g., processing capacity, memory capacity, cooling capacity, etc.), and/or other restrictions that are specific to the host.

In an embodiment, the system determines if assignment of the workload to the candidate device poses a significant risk of exceeding a restriction that does not specifically apply to the candidate device. For instance, the system may determine if assignment of the workload to the candidate device poses a significant risk of exceeding a budget constraint assigned to an ancestor device, an enforcement threshold imposed on an ancestor device, a hardware and/or software limitation of an ancestor device, a hardware and/or software limitation of another device that supports the operation of the candidate device (e.g., an atmospheric regulation device, a network infrastructure device, etc.), and/or other restrictions that do not specifically apply to the candidate device. In an example, the workload is a user instance, and the candidate device is a host that is included in a rack of hosts. In this example, the rack of hosts is distributed electricity through a busway, the busway is distributed electricity through a PDU, and the PDU is distributed electricity through a UPS. Accordingly, the system of this example may determine if the placement of the user instance on the host poses a significant risk of exceeding any budget constraints and/or enforcement thresholds that are applicable to the rack of hosts, the busway, the PDU, and/or the UPS. For the purposes of this example, assume that the PDU includes a circuit breaker that will trip if the trip settings of the circuit breaker are satisfied (i.e., a hardware limitation of an ancestor device). In this example, the system may also determine if placement of the user instance on the host poses a significant risk of exceeding the trip settings of the circuit breaker. For the purposes of this example, further assume that the heat output of the rack of hosts is regulated by in-row cooling system. In this example, the system may determine if the in-row cooling system is already working at or near the maximum capacity of the in-row cooling system, and if placing the user instance on the host poses a significant risk of overwhelming the ability of the in-row cooling system to maintain the heat output of the rack of hosts within acceptable operating parameters (i.e., a hardware limitation of a device that supports the operation of the candidate device).

In an embodiment, the system determines if assignment of the workload to the candidate device poses a significant risk of exceeding a restriction associated with a zone that includes the candidate device. In this embodiment, the devices in the network of devices may be organized into zones, and the zones are respectively associated with restrictions that are applicable to the devices included in the zones. There may be multiple types of zones for different types of restrictions. For instance, there may be power zones associated with power restrictions, chiller zones associated with thermal restrictions, network zones associated with network restrictions, and/or other zones associated with other types of restrictions. The boundaries of the power zones may reflect electricity distribution within the network of devices, the boundaries of the chiller zones may reflect the configuration of atmospheric regulation devices and heat transfer characteristics of a facility that includes the network of devices, and the boundaries of the network zones may reflect the network connections and network capabilities of devices in the network of devices and the configuration of network infrastructure devices that support the network devices. The different types of zones may overlap. For instance, the candidate device may be a constituent of a power zone, a chiller zone, a network zone, and/or other types of zones. Depending on the configuration of the network of devices, the candidate device may belong to more than one zone of a given type. For instance, the candidate device might be a constituent of multiple overlapping power zones. In this embodiment, the system may determine if assignment of the workload to the candidate device poses a significant risk of exceeding any of the restrictions corresponding to any of the zones that the candidate device is a constituent of. In an example, the workload is a user instance, and the candidate device is a host that is included in a rack of hosts. For the purposes of this example, assume that (a) an ancestor device of the rack of hosts is a PDU that includes a circuit breaker, (b) the heat output of the rack of hosts is regulated by an in-row cooling system, and (c) hosts included in the rack of hosts have been assigned user instances of high-priority users. In this example, the rack of hosts belongs to (a) a power zone that is restricted by the trip setting of the PDU's circuit breaker, (b) a chiller zone that is restricted by the capacity of the in-row cooling system and the heat transfer characteristics of a room that includes the rack of hosts, and (c) a network zone constrained by a maximum permissible level of network congestion and/or network latency for devices hosting high-priority users. Accordingly, the system of this example may determine if placing the user instance on the host poses a significant risk of (a) the PDU's circuit breaker tripping, (b) the inability of the in-row cooling system to maintain the thermal zone at a normal operating temperature, and/or (c) an exceeding of maximum permissible congestion and/or latency levels for the high-priority users.

In an embodiment, the system determines if placement of the workload on the candidate device is appropriate based on characteristics of the workload and/or characteristics of the user requesting assignment of the workload. For instance, the system may consider if the user requesting assignment of the workload has requested this type of workload or a similar type of workload in the past. If the user has requested assignment of this type of workload or a similar type of workload in the past, the system may estimate the impact of assigning the workload to the candidate device based on historical data regarding the resource intensity of these workloads. In an example, the request for assignment of the workload is a request by a user for placement of a user instance, and the candidate device is a host that is included in a rack of hosts. In this example, the system may analyze the previous activity of the user to determine if the user has previously requested placement of this particular type of user instance or a similar type of user instance. If the user has previously requested placement of this particular type of user instance or a similar type of user instance, the system may evaluate historical usage data associated with the tasks that were performed by these user instances in this example. Based on the historical usage data, the system may estimate an impact that placement of the user instance will have on the host.

In an embodiment, the system predicts the impact of assigning the workload to the candidate device by using one or more trained machine learning models. For instance, the system may apply a trained machine learning model to predict the resources that will be utilized by the workload, the heat output that will be created by the workload, the network resource that will be occupied by the workload, the computer resources of the candidate device that will be utilized by the workload, and/or other aspects of the workloads impact. The system may train a machine learning model to predict the impact of the workload using sets of training data. An example set of training data includes a particular workload (e.g., a particular type of user instance) and an impact of placing the particular workload on a particular device (e.g., a particular type of host). The system may receive feedback pertaining to predictions generated by the machine learning model, and the machine learning model may be further trained based on the feedback.

In an embodiment, the system assigns the workload to the candidate device (Operation 1008). Upon assigning the workload to the candidate device, the system may generate compute metadata that describes the state of the workload assignment. As an example, assume that the workload is a user instance and the candidate device is a host. In this example, the system may generate a set of compute metadata that includes a timestamp associated with a last update, an instance ID, a host serial, a hypervisor ID, a user tenancy, a user account template, user priority, a cluster ID, an instance state, an IP address, a type, a shape, and/or other information. In this example, the compute control plane may communicate this compute metadata to other components of the system. For instance, the compute metadata may be provided to a control plane of the system, and the control plane may use the compute metadata to generate enforcement metadata that can be used by controllers of an enforcement plane as a basis for budget enforcement determinations.

### 8. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

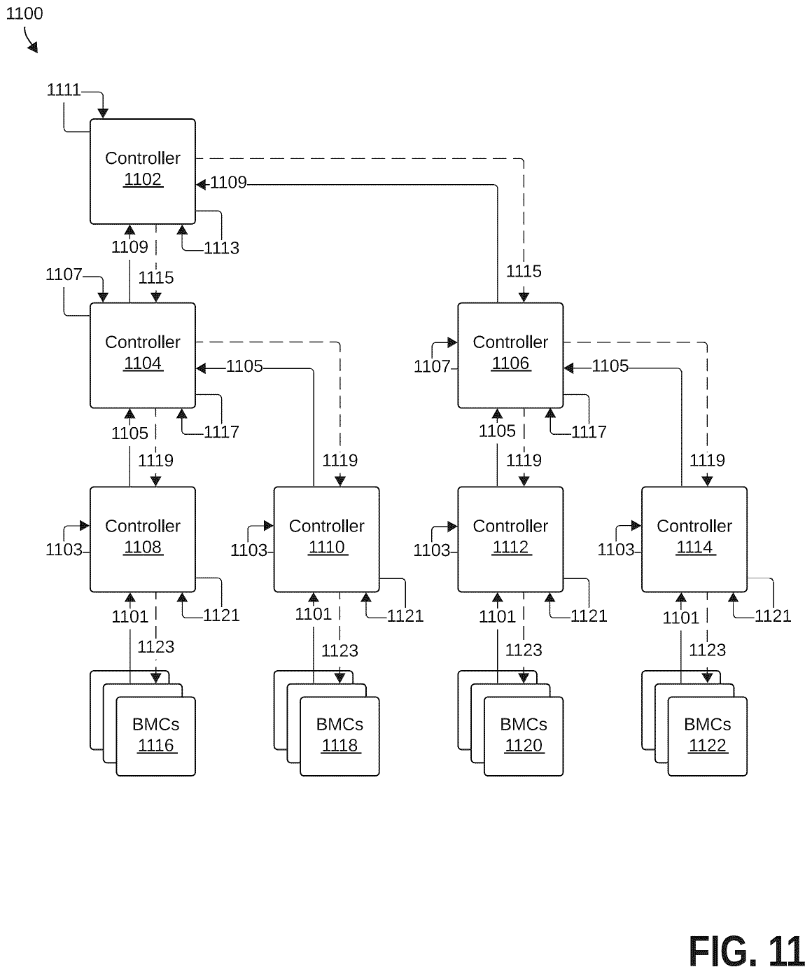

FIG. 11 illustrates an architecture 1100 for enforcing budgeting for a network of devices in accordance with an example embodiment. As illustrated in FIG. 11, architecture 1100 includes controller 1102, controller 1104, controller 1106, controller 1108, controller 1110, controller 1112, controller 1114, BMCs 1116, BMCs 1118, BMCs 1120, and BMCs 1122. In one or more embodiments, an architecture 1100 includes more or fewer components than the components illustrated in FIG. 11.

In an example embodiment, controller 1102 is a control loop spawned in an enforcement plane of the system to manage a device in the network of devices. Controller 1102 is a parent controller to controller 1104 and controller 1106. The device managed by controller 1102 is an ancestor device (e.g., a parent device or a further ancestor device) to the devices that are managed by controller 1104 and controller 1106. For instance, in the example illustrated by FIG. 11, controller 1102 may manage a PDU that distributes electricity to two busways that are respectively managed by controller 1104 and controller 1106. Controller 1102 may be at the top of a hierarchy of controllers included in the enforcement plane, or controller 1102 may be a descendant controller of one or more controllers not illustrated in FIG. 11 (e.g., a controller of a UPS that distributes electricity to a PDU managed by controller 1102). The device manage by controller 1102 may be open or closed to placement. If the device managed by controller 1102 is closed, not workloads can be assigned to the compute devices that are managed by BMCs 1116, BMCs 1118, BMCs 1120, and BMCs 1122.

In an example embodiment, controller 1104 is a control loop spawned in the enforcement plane of the system to manage a device in the network of devices. Controller 1104 is a parent controller of controller 1108 and controller 1110. The device managed by controller 1104 is an ancestor device to the devices that are managed by controller 1108 and controller 1110. For instance, in the example illustrated by FIG. 11, controller 1104 may manage a busway that distributes electricity to two racks of hosts that are respectively managed by controller 1108 and controller 1110. The device managed by controller 1104 may be open or closed to placement. If the device managed by controller 1104 is closed, no additional workloads can be assigned to the compute devices managed by BMCs 1116 and BMCs 1118.

In an example embodiment, controller 1106 is a control loop spawned in the enforcement plane of the system to manage a device in the network of devices. Controller 1106 is a parent controller of controller 1112 and controller 1114. The device managed by controller 1106 is an ancestor device to the devices that are managed by controller 1112 and controller 1114. For instance, in the example illustrated by FIG. 11, controller 1106 may manage a busway that distributes electricity to two racks of hosts that are respectively managed by controller 1112 and controller 1114. The device managed by controller 1106 may be open or closed to placement. If the device managed by controller 1106 is closed, no additional workloads can be assigned to the compute devices managed by BMCs 1120 and BMCs 1122.

In an example embodiment, controller 1108 is a control loop spawned in the enforcement plane of the system to manage a device in the network of devices. Controller 1108 is a leaf-level controller because controller 1108 is situated at the lowest level of the hierarchy of controllers illustrated in FIG. 11. Thus, controller 1108 possesses no child controllers in the enforcement plane of the system. However, the device managed by controller 1108 is an ancestor device to the compute devices that are managed by BMCs 1116. For instance, in the example illustrated by FIG. 11, controller 1108 may manage a rack of hosts, and BMCs 1116 may manage hosts that are included in the rack of hosts and/or are distributed electricity through one or more rPDUs of the rack of hosts. The device managed by controller 1108 may be open or closed to placement. If the device managed by controller 1108 is closed, no additional workloads can be assigned to the compute devices managed by BMCs 1116.

In an example embodiment, controller 1110 is a control loop spawned in the enforcement plane of the system to manage a device in the network of devices. Controller 1110 is a leaf-level controller because controller 1110 is situated at the lowest level of the hierarchy of controllers illustrated in FIG. 11. The device managed by controller 1110 is an ancestor device to the compute devices that are managed by BMCs 1118. For instance, in the example illustrated by FIG. 11, controller 1110 may manage a rack of hosts, and BMCs 1118 may manage hosts that are included in the rack of hosts and/or are distributed electricity through one or more rPDUs of the rack of hosts. The device managed by controller 1110 may be open or closed to placement. If the device managed by controller 1110 is closed, no additional workloads can be assigned to the compute devices managed by BMCs 1118.

In an example embodiment, controller 1112 is a control loop spawned in the enforcement plane of the system to manage a device in the network of devices. Controller 1112 is a leaf-level controller because controller 1112 is situated at the lowest level of the hierarchy of controllers illustrated in FIG. 11. The device managed by controller 1112 is an ancestor device to the compute devices that are managed by BMCs 1120. For instance, in the example illustrated by FIG. 11, controller 1112 may manage a rack of hosts, and BMCs 1120 may manage hosts that are included in the rack of hosts and/or are distributed electricity through one or more rPDUs of the rack of hosts. The device managed by controller 1112 may be open or closed to placement. If the device managed by controller 1112 is closed, no additional workloads can be assigned to the compute devices managed by BMCs 1120.

In an example embodiment, controller 1114 is a control loop spawned in the enforcement plane of the system to manage a device in the network of devices. Controller 1114 is a leaf-level controller because controller 1114 is situated at the lowest level of the hierarchy of controllers illustrated in FIG. 11. The device managed by controller 1114 is an ancestor device to the compute devices that are managed by BMCs 1122. For instance, in the example illustrated by FIG. 11, controller 1114 may manage a rack of hosts, and BMCs 1122 may manage hosts that are included in the rack of hosts and/or are distributed electricity through one or more rPDUs of the rack of hosts. The device managed by controller 1114 may be open or closed to placement. If the device managed by controller 1114 is closed, no additional workloads can be assigned to the compute devices managed by BMCs 1122.

In an example embodiment, BMCs 1116, BMCs 1118, BMCs 1120, and BMCs 1122 are baseboard management controllers that are configured to manage compute devices in the network of devices. For instance, in the example illustrated by FIG. 11, a BMC 1116 may manage a host that is included in a rack of hosts managed by controller 1108. A compute device managed by a BMC may be open or closed to placement.

In an example embodiment, BMCs 1116 report to controller 1108 on the statuses of compute devices managed by BMCs 1116, BMCs 1118 report to controller 1110 on the statuses of compute devices managed by BMCs 1118, BMCs 1120 report to controller 1112 on the statuses of compute devices managed by BMCs 1120, and BMCs 1122 report to controller 1114 on the statuses of compute devices managed by BMCs 1122 (Operation 1101). For instance, in the example illustrated by FIG. 11, a BMC 1116 of a compute device may report on the status of the compute device to controller 1108. In this example, the BMC 1116 may report power consumption measurements of the compute device managed by the BMC 1116 and/or other information pertaining to the status of the compute device managed by the BMC 1166 (e.g., health data, occupancy levels, temperature, etc.).

In an example embodiment, controller 1108 aggregates information reported to controller 1108 by BMCs 1116, controller 1110 aggregates information reported to controller 1110 by BMCs 1118, controller 1112 aggregates information reported to controller 1112 by BMCs 1120, and controller 1114 aggregates information reported to controller 1114 by BMCs 1122 (Operation 1103). For instance, in the example illustrated by FIG. 11, controller 1108 may aggregate measurements of power consumption by compute devices managed by BMCs 1116 to approximate the aggregate power that is being drawn by the device managed by controller 1108 from the device that is being managed by controller 1104.

In an example embodiment, controller 1108 and controller 1110 report to controller 1104 on the statuses of the devices respectively managed by controller 1108 and controller 1110, and controller 1112 and controller 1114 report to controller 1106 on the statuses of the devices respectively managed by controller 1112 and controller 1114 (Operation 1105). For instance, in the example illustrated by FIG. 11, controller 1108 may report to controller 1104 the approximate power draw of the device managed by controller 1108 from the device that is managed by controller 1104 and/or other information pertaining to the status of the device managed by controller 1108.

In an example embodiment, controller 1104 aggregates information reported to controller 1104 by controller 1108 and controller 1110, and controller 1106 aggregates information reported to controller 1106 by controller 1112 and controller 1114 (Operation 1107). For instance, in the example illustrated by FIG. 11, controller 1104 may aggregate approximate measurements of power draw by the devices managed by controller 1108 and controller 1110 to approximate the power that is being drawn by the device managed by controller 1104 from the device that is being managed by controller 1102.

In an example embodiment, controller 1104 and controller 1106 report to controller 1102 on the statuses of the devices respectively managed by controller 1104 and controller 1106 (Operation 1109). For instance, in the example illustrated by FIG. 11, controller 1104 may report to controller 1102 the approximate power draw of the device managed by controller 1104 from the device that is managed by controller 1102.

In an example embodiment, controller 1102 aggregates information reported to controller 1102 by controller 1104 and controller 1106 (Operation 1111). For instance, in the example illustrated by FIG. 11, controller 1102 may aggregate approximate measurements of power draw by the devices managed by controller 1104 and controller 1106 to approximate the power that is being drawn by the device managed by controller 1102 from a parent device (i.e., a device not depicted in FIG. 11).

In an example embodiment, controller 1102 determines if the enforcement settings for the devices managed by controller 1104 and controller 1106 should be updated (Operation 1113). To this end, controller 1102 determines if the device manage by controller 1102 is exceeding or is at risk of exceeding any applicable budget constraints or enforcement thresholds. Controller 1102 may determine if the device of controller 1102 is exceeding or is at risk of exceeding any applicable budget constraints or enforcement thresholds based on the aggregated information that has been reported to controller 1102 by controller 1104 and controller 1106. If the device managed by controller 1102 is exceeding or is at risk of exceeding an applicable restriction, controller 1102 may determine new enforcement thresholds for the device managed by controller 1104 and/or the device managed by controller 1106. Alternatively, if the risk of the device managed by controller 1102 exceeding a restriction has decreased, controller 1102 may determine new enforcement settings that ease and/or lift enforcement thresholds that are currently imposed on the device managed by controller 1104 and/or the device managed by controller 1106.

In an example embodiment, if controller 1102 has determined updated enforcement settings for the device managed by controller 1104 and/or the device managed by controller 1106, controller 1102 may communicate the updated enforcement settings to controller 1104 and/or controller 1106 (Operation 1115). Additionally, or alternatively, controller 1102 may communicate the updated enforcement settings to another enforcement mechanism of the system (e.g., a compute control plane, a user instance controller, an enforcement agent, etc.). If controller 1102 has not updated the enforcement settings for the device managed by controller 1104 or the device managed by controller 1106, controller 1102 may skip this operation.

In an example embodiment, controller 1104 determines if the enforcement settings for the devices managed by controller 1108 and controller 1110 should be updated, and controller 1106 determines if the enforcement settings for the devices managed by controller 1112 and controller 1114 should be updated (Operation 1117). For instance, in the example illustrated by FIG. 11, controller 1104 may determine if the device managed by controller 1104 is exceeding or is at risk of exceeding any applicable budget constraints or enforcement thresholds based on the information that has been aggregated by controller 1104. In this example, an enforcement threshold that is applicable to the device managed by controller 1104 may be a new enforcement threshold that has been communicated to controller 1104 in Operation 1115, and/or an enforcement threshold that is applicable to the device managed by controller 1104 may be a preexisting enforcement threshold. If the device managed by controller 1104 is exceeding or at risk of exceeding an applicable restriction (e.g., a budget constraint or an enforcement threshold) in this example, controller 1104 may determine new enforcement thresholds for the device managed by controller 1108 and/or the device managed by controller 1110. Alternatively, if the risk of the device managed by controller 1104 exceeding an applicable restriction has decreased in this example, controller 1104 may determine new enforcement settings that ease and/or lift enforcement thresholds that are currently imposed on the device managed by controller 1108 and/or the device managed by controller 1110.

In an example embodiment, controller 1104 may communicate updated enforcement settings to controller 1108 and/or controller 1110, and/or controller 1106 may communicate updated enforcement settings to controller 1112 and/or controller 1114 (Operation 1119). For instance, in the example illustrated by FIG. 11, if controller 1104 determined a new enforcement threshold for the device managed by controller 1108, controller 1104 may communicate that new enforcement threshold to controller 1108. Additionally, or alternatively, controller 1104 may communicate the new enforcement threshold to another enforcement mechanism of the system in this example. If controller 1104 has not updated any enforcement settings in this example, controller 1104 may skip this operation.

In an example embodiment, controller 1108 determines if enforcement settings for the compute devices managed by BMCs 1116 should be updated, controller 1110 determines if enforcement settings for the compute devices managed by BMCs 1118 should be updated, controller 1112 determines if enforcement settings for the compute devices managed by BMCs 1120 should be updated, and controller 1114 determines if enforcement settings for the compute devices managed by BMCs 1122 should be updated (Operation 1121). For instance, in the example illustrated by FIG. 11, controller 1108 may determine if the device managed by controller 1108 is exceeding or is at risk of exceeding any applicable budget constraints or enforcement thresholds based on the information that has been aggregated by controller 1108. If the device managed by controller 1108 is exceeding or is at risk of exceeding an applicable restriction (e.g., a budget constraint or an enforcement threshold) in this example, controller 1108 may determine new enforcement thresholds for one or more of the compute devices managed by BMCs 1116. Alternatively, if the risk of the device managed by controller 1108 exceeding an applicable restriction has decreased in this example, controller 1108 may determine new enforcement settings that ease and/or lift enforcement thresholds that are currently imposed on the compute devices managed by BMCs 1116.

In an example embodiment, controller 1108 may communicate updated enforcement settings to BMCs 1116, controller 1110 may communicate updated enforcement settings to BMCs 1118, controller 1112 may communicate updated enforcement settings to BMCs 1120, and/or controller 1114 may communicate updated enforcement settings to BMCs 1122 (Operation 1123). For instance, in the example illustrated by FIG. 11, if controller 1108 has determined a new enforcement threshold for a compute device managed by a BMC 1116 in Operation 1121, controller 1108 may communicate that new enforcement threshold to that BMC 1116 in this operation. The new enforcement threshold will subsequently be enforced by that BMC 1116. Additionally, or alternatively, controller 1108 may communicate that enforcement threshold to another enforcement mechanism of the system in this example. If controller 1108 has not updated any enforcement mechanisms in this example, controller 1108 may skip this operation.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
determining, by a controller of a device, a power draw value of the device, wherein the device is associated with a plurality of descendant devices of the device;
comparing, by the controller of the device, the power draw value of the device to a restriction on power draw of the device, wherein the restriction on the power draw of the device is (a) a budget constraint assigned to the device or (b) a power cap threshold imposed on the device; and
responsive to determining, by the controller of the device, that the power draw value of the device exceeds the restriction on the power draw of the device:
based, at least in part, on a set of one or more attributes indicating a current state of the plurality of descendant devices of the device, determining, by the controller of the device, a set of one or more power cap thresholds for a set of one or more descendant devices of the device,
wherein the method is performed by at least one device including a hardware processor.

2. The method of claim 1:
wherein the plurality of descendant devices comprises a first descendant device;
wherein the set of one or more attributes comprises at least one of:
(a) a first level of priority of a first workload associated with the first descendant device,
(b) a first health metric associated with the first descendant device, or
(c) a first occupancy level associated with the first descendant device.

3. The method of claim 1:
wherein the plurality of descendant devices comprises a first descendant device and a second descendant device;
wherein a first workload is currently assigned to the first descendant device and a second workload is currently assigned to the second descendant device;
wherein the set of one or more attributes comprises (a) a first level of priority associated with the first workload and (b) a second level of priority associated with the second workload;
wherein the set of one or more power cap thresholds is determined based, at least in part, on the first level of priority associated with the first workload being greater than the second level of priority associated with the second workload;
wherein the set of one or more power cap thresholds comprises at least one of (a) a first power cap threshold for the first descendant device or (b) a second power cap threshold for the second descendant device; and
wherein the set of one or more power cap thresholds comprises the second power cap threshold for the second descendant device;
wherein the second power cap threshold for the second descendant device is more restrictive than the first power cap threshold for the first descendant device.

4. The method of claim 3, wherein the first descendant device is a first host, wherein the second descendant device is a second host, wherein the first workload is a first user instance, wherein the first user instance is associated with a first user, wherein the second workload is a second user instance, wherein the second user instance is associated with a second user, and further comprising:
prior to determining the set of one or more power cap thresholds:
determining the first level of priority associated with the first workload based, at least in part, on a first set of metadata associated with the first user;
determining the second level of priority associated with the second workload based, at least in part, on a second set of metadata associated with the second user.

5. The method of claim 1:
wherein the plurality of descendant devices comprises a first descendant device and a second descendant device;
wherein the set of one or more attributes comprises (a) a first level of occupancy associated with the first descendant device and (b) a second level of occupancy associated with the second descendant device;
wherein the set of one or more power cap thresholds is determined based, at least in part, on the first level of occupancy associated with the first descendant device being greater than the second level of occupancy associated with the second descendant device;
wherein the set of one or more power cap thresholds comprises at least one of (a) a first power cap threshold for the first descendant device or (b) a second power cap threshold for the second descendant device;
wherein the set of one or more power cap thresholds comprises the second power cap threshold for the second descendant device; and
wherein the second power cap threshold for the second descendant device is more restrictive than the first power cap threshold for the first descendant device.

6. The method of claim 1:
wherein the plurality of descendant devices comprises a first descendant device and a second descendant device;
wherein the set of one or more attributes comprises (a) a first health metric associated with the first descendant device and (b) a second health metric associated with the second descendant device;
wherein the set of one or more power cap thresholds is determined based, at least in part, on the first health metric associated with the first descendant device and the second health metric associated with the second descendant device indicating that the first descendant device is healthier than the second descendant device;
wherein the set of one or more power cap thresholds comprises at least one of (a) a first power cap threshold for the first descendant device or (b) a second power cap threshold for the second descendant device;
wherein the set of one or more power cap thresholds comprises the second power cap threshold for the second descendant device; and
wherein the second power cap threshold for the second descendant device is more restrictive than the first power cap threshold for the first descendant device.

7. The method of claim 1, wherein the set of one or more power cap thresholds comprises a first power cap threshold for a first descendant device, wherein the first descendant device is comprised within the plurality of descendant devices of the device, wherein electricity is distributed from the device to the first descendant device, wherein the first descendant device is managed by a first descendant controller, wherein the first descendant controller is a child controller of the controller of the device, and further comprising:
determining, by the first descendant controller, a first power draw value of the first descendant device, wherein the first descendant device is associated with a first plurality of descendants of the first descendant device;
subsequent to receiving, by the first descendant controller, the first power cap threshold for the first descendant device from the controller of the device:
comparing, by the first descendant controller, the first power draw value of the first descendant device to the first power cap threshold for the first descendant device; and
responsive to determining, by the first descendant controller, that the first power draw value of the first descendant device exceeds the first power cap threshold for the first descendant device:
based, at least in part, on a first set of one or more attributes indicating a first current state of the first plurality of descendant devices of the first descendant device, determining, by the first descendant controller, a first set of one or more power cap thresholds for a first set of one or more descendant devices of the first descendant device.

8. The method of claim 1, wherein the controller of the device is a leaf-level controller, wherein the plurality of descendant devices comprises a first host, wherein the set of one or more power cap thresholds comprises a first power cap threshold for the first host, wherein the first host is managed by a baseboard management controller (BMC), and further comprising:
subsequent to receiving, by the BMC, the first power cap threshold for the first host from the controller of the device:
restricting, by the BMC, power consumption of the first host in accordance with the first power cap threshold for the first host,
wherein restricting the power consumption of the first host comprises at least one of:
(a) restricting a first amount of power consumed by a graphics processing unit (GPU) of the first host,
(b) restricting a second amount of power consumed by a central processing unit (CPU) of the first host, or
(c) shutting down the first host.

9. The method of claim 1, wherein the plurality of descendant devices comprises a first descendant device, wherein the set of one or more power cap thresholds comprises a first power cap threshold for the first descendant device, and further comprising:
enforcing the first power cap threshold by performing at least one of:
(a) preventing an additional user instance from being assigned to a host, wherein the first descendant device is either (a) an ancestor device of the host or (b) the host,
(b) restricting, by a user instance controller of the host, activity of a user instance currently assigned to the host, wherein the user instance controller is comprised within a hypervisor level of the host, or
(c) restricting, by an enforcement agent, activity of a user associated with the user instance currently assigned to the host, wherein the enforcement agent is executing on a computer system of the user.

10. The method of claim 1, further comprising:
prior to determining the power draw value of the device:
obtaining, by the controller of the device, a plurality of power draw values, wherein a first power draw value of the plurality of power draw values indicates a first amount of power that is being drawn from the device by a first descendant device of the plurality of descendant devices of the device; and
subsequent to obtaining the plurality of power draw values:
calculating a sum of the plurality of power draw values, wherein determining the power draw of value of the device is based, at least in part, on the sum of the plurality of power draw values.

11. The method of claim 1:
wherein electricity is being distributed to the device from a first ancestor device of the device;
wherein the electricity is being distributed from the device to the plurality of descendant devices;
wherein the restriction on the power draw of the device is the power cap threshold imposed on the device;
wherein the power cap threshold is imposed on the device by a first ancestor controller of the first ancestor device;
wherein the first ancestor controller is a parent controller of the controller of the device; and
wherein the first ancestor controller of the first ancestor device determines the power cap threshold imposed on the device based, at least in part, on at least one of:
(a) a level of priority of a workload associated with the device,
(b) a health metric associated with the device, or
(c) an occupancy level associated with the device.

12. The method of claim 1, further comprising:
responsive to receiving a request for assignment of a workload, identifying a first candidate device for assignment of the workload, wherein the first candidate device is comprised within the plurality of descendant devices of the device;
determining an actual or predicted impact of assigning the workload to the first candidate device; and
responsive to determining that the actual or predicted impact of assigning the workload to the first candidate device does not exceed a first set of one or more restrictions associated with the first candidate device, assigning the workload to the first candidate device,
wherein the first set of one or more restrictions associated with the first candidate device comprises at least one of:
(a) a budget assigned to the device,
(b) an enforcement threshold imposed on the device,
(c) a hardware and/or software limitation of the device,
(d) a first budget assigned to the first candidate device,
(e) a first enforcement threshold imposed on the first candidate device,
(f) a first hardware and/or software limitation of the first candidate device, or
(g) a second hardware and/or software limitation of an infrastructure device that supports operation of the first candidate device.

13. The method of claim 12:
wherein identifying the first candidate device is based, at least in part, on determining that the first candidate device is not closed to assignment of new workloads;
wherein the infrastructure device that supports the operation of the first candidate device is an atmospheric regulation device or a network infrastructure device;
wherein the workload is a user instance;
wherein the first candidate device is a first candidate host;
wherein determining the actual or predicted impact of assigning the workload to the first candidate device is based, at least in part, on at least one of:
(a) a first current state of the first candidate host,
(b) a first type of the user instance,
(c) a first characteristic of a user requesting assignment of the user instance, or
(d) historical data associated with the first type of the user instance and/or the user requesting assignment of the user instance.

14. The method of claim 13, wherein determining the actual or predicted impact of assigning the workload to the first candidate device comprises:
training a machine learning model to determine actual or predicted impacts of assigning user instances to hosts with sets of training data,
wherein a set of training data of the sets of training data defines an association between (a) assigning a particular user instance to a particular host and (b) a particular impact of assigning the particular user instance to the particular host;
applying the machine learning model to determine the actual or predicted impact of assigning the workload to the first candidate device;
obtaining feedback regarding the actual or predicted impact of assigning the workload to the first candidate device; and
further training the machine learning model based on the feedback regarding the actual or predicted impact of assigning the workload to the first candidate device.

15. The method of claim 13:
wherein the set of one or more restrictions comprises:
(a) a power restriction associated with the first candidate device,
(b) a thermal restriction associated with the first candidate device, and
(c) a network restriction associated with the first candidate device;
wherein the first current state of the first candidate host describes at least one of:
(a) a first power draw value associated with the first candidate host,
(b) a first temperature associated with first candidate host, or
(c) a first utilization level of network resources available to the first candidate host; and
wherein the workload is assigned to the first candidate device based, at least in part, on determining that the actual or predicted impact of assigning the workload to the first candidate device does not exceed the power restriction associated with the first candidate device, the thermal restriction associated with the first candidate device, or the network restriction associated with the first candidate device.

16. The method of claim 12:
wherein the plurality of descendant devices is divided into a plurality of zones,
wherein the first candidate device is comprised within at least one of:
(a) a power zone associated with one or more power restrictions,
(b) a chiller zone associated with one or more thermal restrictions, or
(c) a network zone associated with one or more network restrictions;
wherein the set of one or more restrictions comprises at least one of:
(a) the one or more power restrictions associated with the power zone,
(b) the one or more thermal restrictions associated with the chiller zone, or
(c) the one or more network restrictions associated with the network zone; and
wherein the workload is assigned to the first candidate device based, at least in part, on determining that the actual or predicted impact of assigning the workload to the first candidate device does not exceed the one or more thermal restrictions associated with the chiller zone, the one or more thermal restrictions associated with the chiller zone, or the one or more network restrictions associated with the network zone.

17. One or more non-transitory computer-readable media comprising instructions that, when executed by one or more hardware processors, cause performance of operations comprising:
determining, by a controller of a device, a power draw value of the device, wherein the device is associated with a plurality of descendant devices of the device;
comparing, by the controller of the device, the power draw value of the device to a restriction on power draw of the device, wherein the restriction on the power draw of the device is (a) a budget constraint assigned to the device or (b) a power cap threshold imposed on the device; and
responsive to determining, by the controller of the device, that the power draw value of the device exceeds the restriction on the power draw of the device:
based, at least in part, on a set of one or more attributes indicating a current state of the plurality of descendant devices of the device, determining, by the controller of the device, a set of one or more power cap thresholds for a set of one or more descendant devices of the device.

18. The one or more non-transitory computer-readable media of claim 17:
wherein the plurality of descendant devices comprises a first descendant device;
wherein the set of one or more attributes comprises at least one of:
(a) a first level of priority of a first workload associated with the first descendant device,
(b) a first health metric associated with the first descendant device, or
(c) a first occupancy level associated with the first descendant device.

19. The one or more non-transitory computer-readable media of claim 17:
wherein the plurality of descendant devices comprises a first descendant device and a second descendant device;
wherein a first workload is currently assigned to the first descendant device and a second workload is currently assigned to the second descendant device;
wherein the set of one or more attributes comprises (a) a first level of priority associated with the first workload and (b) a second level of priority associated with the second workload;
wherein the set of one or more power cap thresholds is determined based, at least in part, on the first level of priority associated with the first workload being greater than the second level of priority associated with the second workload;
wherein the set of one or more power cap thresholds comprises at least one of (a) a first power cap threshold for the first descendant device or (b) a second power cap threshold for the second descendant device;
wherein the set of one or more power cap thresholds comprises the second power cap threshold for the second descendant device; and
wherein the second power cap threshold for the second descendant device is more restrictive than the first power cap threshold for the first descendant device.

20. The one or more non-transitory computer-readable media of claim 19, wherein the first descendant device is a first host, wherein the second descendant device is a second host, wherein the first workload is a first user instance, wherein the first user instance is associated with a first user, wherein the second workload is a second user instance, wherein the second user instance is associated with a second user, and further comprising:
prior to determining the set of one or more power cap thresholds:
determining the first level of priority associated with the first workload based, at least in part, on a first set of metadata associated with the first user;
determining the second level of priority associated with the second workload based, at least in part, on a second set of metadata associated with the second user.
